(19) United States
(12) Patent Application Publication
(10) Pub. No.: US 2026/0084639 A1
(43) Pub. Date: Mar. 26, 2026

(54) VEHICLE POWER NETWORK MANAGEMENT

(71) Applicant: Daimler Truck North America LLC, Portland, OR (US)

(72) Inventors: Kevin DOANE, Portland, OR (US); Ethan OTT, Portland, OR (US); Moayed EL GAML, Portland, OR (US); Coleman BOYD, Portland, OR (US)

(21) Appl. No.: 19/338,900

(22) Filed: Sep. 24, 2025

Related U.S. Application Data
(60) Provisional application No. 63/698,419, filed on Sep. 24, 2024.

(51) Int. Cl. B60R 16/023; B60R 16/03; H02M 1/00

(52) U.S. Cl. CPC B60R 16/0232; B60R 16/0307; H02M 1/0012; H02M 1/0025

(57) ABSTRACT

Aspects of the present disclosure includes a method for energy management, including obtaining an engine speed of an engine, an alternator speed of an alternator, and a pulley ratio associated with the engine and the alternator, calculating a belt slip value of a belt coupled to the engine and the alternator based on at least one of the engine speed, the alternator speed, or the pulley ratio, detecting a belt slip of the based on the belt slip value and a slip threshold value, and decreasing, in response to detecting the belt slip, a voltage setpoint of a converter connected to the alternator from an initial voltage setpoint to a target voltage setpoint.

### CROSS-REFERENCE TO RELATED APPLICATIONS

The present application claims priority to, and the benefit of, U.S. Provisional Application 63/698,419 filed Sep. 24, 2024 and entitled “VEHICLE ENERGY MANAGEMENT,” the contents of which are hereby incorporated in their entireties.

### FIELD

This disclosure relates to systems and methods for operating power network management systems.

### BACKGROUND

Vehicles such as Class 8 trucks constitute a substantial amount of traffic on the highways due to freight services provided by them. Each year, the demand for moving freight increases, resulting in more such vehicles on roads. Autonomous vehicles may be used to meet the increase in demand. For example, autonomous vehicles may be used to move freight faster (e.g., arriving at the destination sooner) and/or at lower costs. The use and operation of autonomous vehicles, however, may involve additional features relative to manually operated vehicles in order to ensure the proper operation of the autonomous vehicles. Components within vehicular power systems such as redundant autonomous power networks may at times exceed various electrical limits or mechanical limits resulting in a reduction in uptime of system components. Therefore, improvements in the architecture of the autonomous vehicles may be desirable.

### SUMMARY

Described herein are exemplary systems and methods for operating and managing energy in a vehicular power system to prevent components from exceeding various electrical and mechanical limits or mitigate detrimental effects of the limits being exceeded. A set of controls software, control networks/communications, and hardware works in conjunction to limit power usage at relevant devices under specific conditions.

Aspects of the present disclosure includes a method for energy management, including obtaining an engine speed of an engine, an alternator speed of an alternator, and a pulley ratio associated with the engine and the alternator, calculating a belt slip value of a belt coupled to the engine and the alternator based on at least one of the engine speed, the alternator speed, or the pulley ratio, detecting a belt slip of the based on the belt slip value and a slip threshold value, and decreasing, in response to detecting the belt slip, a voltage setpoint of a converter connected to the alternator from an initial voltage setpoint to a target voltage setpoint.

Aspects of the present disclosure include a method of energy management including determining, based on the engine RPM present value signal, an alternator power limit associated with the alternator, comparing the alternator power limit to an alternator power indicated in the alternator power present value signal, determining that the alternator power is higher than the alternator power limit, and transmitting a first signal to a converter to set a converter power limit to a first value.

Aspects of the present disclosure include a method of energy management including determining, based on the alternator capability signal, an alternator power capability limit, comparing the alternator power capability limit to the alternator power indicated in the alternator power present value signal, determining that the alternator power is higher than the alternator power capability limit, and transmitting a third signal to the converter to set the converter power limit to a third value.

The various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosure will become more apparent from the following detailed description, claims, and accompanying figures.

### BRIEF DESCRIPTION OF THE DRAWINGS

In the description that follows, like parts are marked throughout the specification and drawings with the same numerals. The drawing figures are not necessarily drawn to scale and certain figures may be shown in exaggerated or generalized form in the interest of clarity and conciseness. The disclosure itself, as well as a preferred mode of use and further advantages thereof, will be best understood by reference to the following detailed description of illustrative aspects of the disclosure when read in conjunction with the accompanying drawings, wherein:

FIG. 1 is a block diagram of an electrical system of a vehicle according to aspects of the present disclosure.

FIG. 2 is a block diagram of a power distribution network according to aspects of the present disclosure.

FIG. 3 is a block diagram of an electrical system including indications relating to power management and distribution, and without the communication network, according to aspects of the present disclosure.

FIG. 4 is a block diagram of a power generator and an input voltage diagram including indications relating to power management and distribution, according to aspects of the present disclosure.

FIG. 5 is a block diagram of a controller according to aspects of the present disclosure.

FIG. 6 is a block diagram of the communication networks in the electrical system according to aspects of the present disclosure.

FIG. 7 is a block diagram of the power distribution device according to aspects of the present disclosure.

FIG. 8 is a flow chart of a method for operating a power distribution device to detect a degradation according to aspects of the present disclosure.

FIG. 9 is a flow chart illustrating a method of adjusting a setpoint of a voltage converter, according to aspects of the present disclosure.

FIG. 10 is a flow chart illustrating a method of detecting a belt slip, according to aspects of the present disclosure.

FIG. 11 is a flow chart illustrating a method of setting an alternator power limit, according to aspects of the present disclosure.

FIG. 12 is a flow chart illustrating a method of setting a converter power limit, according to aspects of the present disclosure.

FIG. 13 is a flow chart illustrating a method of limiting a voltage converter setpoint, according to aspects of the present disclosure.

FIG. 14 is a block diagram of a method for energy management according to an aspect of the present disclosure.

FIG. 15 is a flow chart illustrating a method for active belt slip detection according to aspects of the present disclosure.

FIG. 16 is a flow chart illustrating a method for alternator power limiting determination according to aspects of the present disclosure.

FIG. 17A is a flow chart illustrating a method for alternator RPM based power limiting determination according to aspects of the present disclosure.

FIG. 17B is a graph of calibration values for alternator speed power limiting according to aspects of the present disclosure.

FIG. 18 is a flow chart illustrating a method for converter power limit determination according to an aspect of the present disclosure.

FIG. 19 is a flow chart illustrating a method for converter setpoint determination according to an aspect of the present disclosure.

FIG. 20 is a block diagram illustrating an example of an operational scheme for energy management according to various aspects of the present disclosure.

FIG. 21 is a flow chart illustrating a first method of implementing energy management according to aspects of the aspects of the present disclosure.

FIG. 22 is a flow chart illustrating a second method of implementing energy management according to aspects of the aspects of the present disclosure.

FIG. 23 is a flow chart illustrating a third method of implementing energy management according to aspects of the aspects of the present disclosure

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The present disclosure may be embodied in other specific forms without departing from its spirit or characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

Aspects of the present disclosure relate to a vehicle having autonomous capabilities, including an “autonomous vehicle” and a “semi-autonomous vehicle.” Such vehicles may also be referred to as a self-driving vehicle, driverless vehicle, or robotic vehicle. While an autonomous vehicle may be driverless, a semi-autonomous vehicle includes a human driver to monitor the environment and be ready to take control when necessary. And, as used herein, autonomous capabilities for a vehicle refers to vehicular automation, that is, technology that can sense its environment and allow a vehicle to move safely with little or no human input. Autonomous and semi-autonomous vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage. The control systems further control the physical operation of the vehicle, e.g., via one or more actuators, based on the sensor information. In the following description, the terms autonomous vehicle and semi-autonomous vehicle may be used interchangeably and/or substituted for one another, unless stated otherwise, and generally refer to a vehicle having autonomous capabilities.

In one aspect of the present disclosure, for certain vehicles such as autonomous vehicles, there can be certain operational requirements. For example, certain electrical loads may be in a “always-on” state to ensure proper communication and/or security. Certain electrical loads associated with autonomous driving may draw significant power during flashing and/or updates. In certain times, the autonomous driving loads may be operated without running the engine. The batteries may require the storage of a threshold amount of electrical energy for certain applications, thus requiring a sufficient charging capability. The on-board power busses (i.e., power distribution networks) may require the ability to isolate for integrity/safety reasons.

Some aspects of the present disclosure include an electrical system for a vehicle, such as an autonomous or semi-autonomous vehicle. Examples of autonomous vehicles include vehicles that are classified by the Society of Automotive Engineers (SAE). For example, classes 3, 4, or 5 vehicles may be the autonomous vehicles described herein. Other standards or types of autonomous vehicles may also encompass one or more aspects of the present disclosure. The electrical system may be configured to be charged by various input power supplies that run on different supply voltages. Based on the supply voltage, operating conditions, battery statuses, and/or other factors, the electrical system may distribute the electrical energy to various components within the vehicle.

According to aspects of the present disclosure, certain system limits are detected. Based on the type of limit that is detected, a corresponding a power limitation is implemented at the DCDC chargers (also referred to as converters) and/or the alternator.

In some examples, the disclosed method can include detecting a belt slip of a belt coupled to an engine and an alternator, setting a power output limit of the alternator based on a pulley ratio of the belt, an engine speed of the engine, and an alternator speed of the alternator, and decreasing a voltage setpoint of a voltage converter connected to the alternator from a nominal voltage setpoint to a minimum voltage setpoint, wherein the minimum voltage setpoint can be based on the power output limit of the alternator.

In some examples, the disclosed method can include, for each DC-DC voltage converter in a plurality of DC-DC voltage converters, measuring a power output of the DC-DC voltage converter and receiving a power capability of the DC-DC voltage converter. The method can further include, for each DC-DC voltage converter in the plurality of DC-DC voltage converters whose power output exceeds its power capability, setting a voltage setpoint of the DC-DC voltage converter to a minimum voltage setpoint. The method can further include, for each DC-DC voltage converter in the plurality of DC-DC voltage converters whose power output does not exceed its power capability, setting the voltage setpoint of the DC-DC voltage converter to a nominal voltage setpoint greater than the minimum voltage setpoint.

In some examples, the disclosed method can include calculating a slip value based on a pulley ratio of a belt coupled to an engine and an alternator, an engine speed, and an alternator speed, wherein the slip value can be greater than a slip value threshold, and decreasing a power output limit of the alternator to a minimum power output limit.

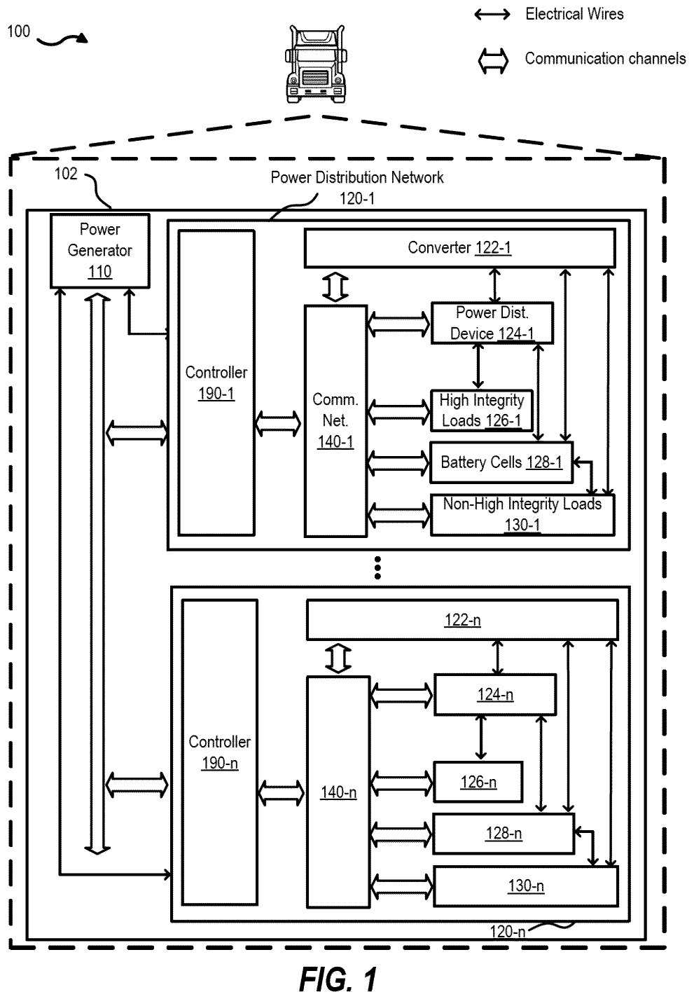

FIG. 1 is a block diagram showing an electrical system 102 of a vehicle 100 having a power distribution device or a controller configured to identify a degradation (e.g., a degradation beyond a predetermined threshold) within the electrical system 102 and/or the vehicle 100 and maintain a supply of power to components within the electrical system 102 directed to high integrity operation of the vehicle 100, e.g., high integrity components or loads, according to an aspect of the present disclosure. In some aspects, the electrical system 102 may include a power generator 110 configured to supply electrical energy to various components of the electrical system 102 as described below. The power generator 110 may include, but is not limited to, an alternator configured to generate an alternator current, and, optionally, a filter configured to filter the alternator current to generate an output current to provide a first electrical energy to the electrical system 102. The electrical system 102 may include two or more power distribution networks 120-1 . . . 120-n each having various circuitry and devices configured to operate various components of the vehicle 100. Here, the number n may be any positive integer greater than 1.

In some aspects, the first power distribution network 120-1 may include one or more first converters 122-1 configured to convert an input voltage to an output voltage. The one or more first converters 122-1 may include one or more power converter devices, such as but not limited to a DC-DC transformer, one or more rectifiers, and/or one or more passive/active electrical devices (e.g. resistor(s), capacitor(s), inductor(s), etc.). The first power distribution network 120-1 may include a first power distribution device 124-1 configured to manage electrical energy distribution within the first power distribution network 120-1. The first power distribution device 124-1 may include, but is not limited to, one or more switches. Examples of the one or more switches may include metal-oxide-semiconductor field effect transistors (MOSFETs), bipolar junction transistors (BJT), and/or other types of electronic switches configured to toggle between high impedance state and low impedance state. In some aspects, the switches may be driven by hardware and/or software.

In certain aspects of the present disclosure, the first power distribution network 120-1 may include a first plurality of high integrity loads 126-1 that include systems necessary for the vehicle 100 to operate safely during an occurrence of a degradation. In one aspect of the present disclosure, the term high integrity load as used herein refers to high integrity loads compliant with the ISO 26262 standards. In an implementation, the high integrity loads include an automotive safety integrity level D (ASIL-D) or ASIL-B(D) loads providing the required control for the proper maneuvering of the vehicle. In one example, the first plurality of high integrity loads 126-1 may include one or more of a brake system, a steering system, a visual sensor system, a virtual driver system, a fuel pump system, and/or other systems that contribute to the proper operation of the vehicle 100.

In an aspect of the present disclosure, the first power distribution network 120-1 may include a first plurality of battery cells 128-1 configured to store electrical energy. Further, the first plurality of battery cells 128-1 may be configured supply the stored electrical energy to various components inside or outside the electrical system 102 as described in further detail below.

In one aspect, the first power distribution network 120-1 may include a first plurality non-high integrity loads 130-1 that include systems that are not necessary for the vehicle 100 to operate safely during an occurrence of a degradation. In one aspect of the present disclosure, the term non-high integrity loads as used herein refers to quality managed (QM) loads in the vehicle. The QM loads may form the least critical workload according to the International Organization for Standardization (ISO) 26262 functional safety standard. QM loads are non-high integrity loads such that the degradation of such loads does not have an adverse effect on the vehicle operation. The QM loads may include, but are not limited to, loads such as audio system, internal lighting, cooling or heating, etc. In an example, the first plurality non-high integrity loads 130-1 may include one or more of a lighting system, an entertainment system, a navigation system, a heating, ventilation, and air conditioning system, and/or other systems or loads that do not interfere with the proper operation of the electrical system 102 and/or vehicle 100.

In some aspects of the present disclosure, the first power distribution network 120-1 may include a first communication network 140-1 configured to provide a communication medium for the components of the first power distribution network 120-1 to communicate with one another. In one instance, the first communication network 140-1 may include a controller area network (CAN) within the first power distribution network 120-1. In another aspect, the first communication network 140-1 may include a local area network (LAN) within the first power distribution network 120-1. Other types of communication networks and/or other communication protocols may also be implemented according to various aspects of the present disclosure.

As used herein, the term “communication network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

In certain aspects of the present disclosure, the electrical system 102 may include the two or more power distribution networks 120-1 . . . 120-n to provide redundancy in the operation of the vehicle 100. As such, in response to a partial or complete degradation of one power distribution network of the two or more power distribution networks 120-1 . . . 120-n, another power distribution network may begin or continue operating the vehicle 100 at full or partial capacity. Each of the two or more power distribution networks 120-1 . . . 120-n may include the same or different components as described above. For example, the n^{th} power distribution network 120-n may include one or more n^{th} converters 122-n, an n^{th} power distribution device 124-n, an n^{th} plurality of high integrity loads 126-n, an n^{th} plurality of battery cells 128-n, an n^{th} plurality of non-high integrity loads 130-n, and/or an n^{th} communication network 140-n as described above.

In one aspect, the first plurality of high integrity loads 126-1 may include identical systems as the n^{th} plurality of high integrity loads 126-n. For example, both the first plurality of high integrity loads 126-1 and the n^{th} plurality of high integrity loads 126-n may include braking systems and steering systems. In another aspect, each plurality of high integrity loads may include different systems necessary for the proper operation of the vehicle 100, such as braking and/or steering systems.

In certain aspects, if the electrical system 102 includes more than two power distribution networks, each plurality of high integrity loads may include the same or different loads or systems as one or more other plurality of high integrity loads.

In some aspects of the present disclosure, the communication networks 140-1 . . . 140-n may be separate networks, or integrated as a single communication network. For example, the communication networks 140-1 . . . 140-n may be part of a single CAN or LAN within the electrical system 102.

In an aspect of the present disclosure, the electrical system 102 may include a plurality of controllers 190-1 . . . 190-n each configured to control various operations of the components within the electrical system 102. The plurality of controllers 190-1 . . . 190-n may each be configured to transmit signals to, and/or receive signals from, various components via communication channels (e.g., electrical and/or optical wires, or wireless communication channels) of the electrical system 102 and/or one or more of the communication networks 140-1 . . . 140-n. In an example, each of the plurality of controllers 190-1 . . . 190-n may be implemented as a single device that executes stored instructions to implement various functions of various electronic control units (ECUs). In another example, each of the plurality of controllers 190-1 . . . 190-n may be implemented as a number of standalone ECUs each embedded with a corresponding component of the electrical system 102 (e.g., a converter ECU for the converter, a power distribution ECU for the power distribution device, etc.). In one implementation, each of the plurality of controllers 190-1 . . . 190-n may be integrated into the respective power distribution device 124. As such, each of the plurality of controllers 190-1 . . . 190-n may function as the “master” controller for operating the respective power distribution network 120. Other configurations may also be implemented according to various aspects of the present disclosure.

The term “electronic control unit” (ECU), also known as an “electronic control module,” is a system and/or processor(s) that controls one or more subsystems. An ECU may be installed in a truck or other motor vehicle. It may refer to many ECUs, and can include, but is not limited to, control units such as an Engine Control Module (ECM), a Powertrain Control Module (PCM), a Transmission Control Module (TCM), a Brake Control Module (BCM) or Electronic Brake Control Module (EBCM), a Central Control Module (CCM), a Central Timing Module (CTM), a General Electronic Module (GEM), a Body Control Module (BCM), and a Suspension Control Module (SCM). ECUs together are sometimes referred to collectively as the vehicle computer or the vehicle central computer, and may include separate computers. In an example, the electronic control unit can be an embedded system in automotive electronics. In another example, the electronic control unit is wirelessly coupled with the automotive electronics.

Aspects of the present disclosure may include the electrical system 102 being configured to rely on one or more backup systems to continue the proper operation of the vehicle 100 during a degradation of a component of the electrical system 102. Examples of a degradation within the electrical system 102 and/or the vehicle 100 may include a degradation in the power generator 110 (e.g., alternator degradation, short circuit, open circuit, etc.), an open electrical wire, a failed converter, a short in the electrical wires, or other degradations that may interfere with proper operation of the electrical system 102 and/or vehicle 100.

In operation, at least one of the power distribution devices 124-1 to 124-n, and/or one of the plurality of controllers 190-1 . . . 190-n, is configured to identify a degradation within the electrical system 102 and/or the vehicle 100. In response, in order to maintain a proper operation of the vehicle 100 in view of the degradation, the respective power distribution device 124-1 to 124-n, and/or one of the plurality of controllers 190-1 . . . 190-n, is configured to maintain a supply of power to at least one of the plurality of high integrity loads 126-1 to 126-n, such as by directing and/or re-directing (e.g., via one or more switches) power from the generator 110 and/or at least one of the plurality of battery cells 128-1 to 128-n to the at least one of the plurality of high integrity loads 126-1 to 126-n, as described in more detail below. Additionally, in some cases, in view of the degradation and to conserve the available power for the at least one of the plurality of high integrity loads 126-1 to 126-n, the respective power distribution device 124-1 to 124-n, and/or one of the plurality of controllers 190-1 . . . 190-n, is configured to reduce and/or disconnect a supply of power to at least one or all of the plurality of non-high integrity loads 130-1 to 130-n.

In certain aspects of the present disclosure, the controller 190 may be configured to detect a degradation within the electrical system 102 as described below. A degradation may be an event that occurs within the electrical system 102 that negatively impacts the operation of the electrical system 102.

In some aspects of the present disclosure, at least some of the two or more power distribution networks 120-1 . . . 120-n may be disposed at different physical locations within the vehicle 100. As such, any positional dependent degradation to a particular location of the vehicle 100 is less likely to incapacitate all of the two or more power distribution networks 120-1 . . . 120-n. In other words, a positional dependent degradation to a particular location of the vehicle 100 may be less likely to stop the supply of electrical energy to at least one of the plurality of high integrity loads 126, which will allow the electrical system 102 to continue operating the vehicle 100 (e.g., steering and/or braking the vehicle 100).

Other configurations may also be implemented according to aspects of the present disclosure. Detailed descriptions of the plurality of controllers 190-1 . . . 190-n are described below.

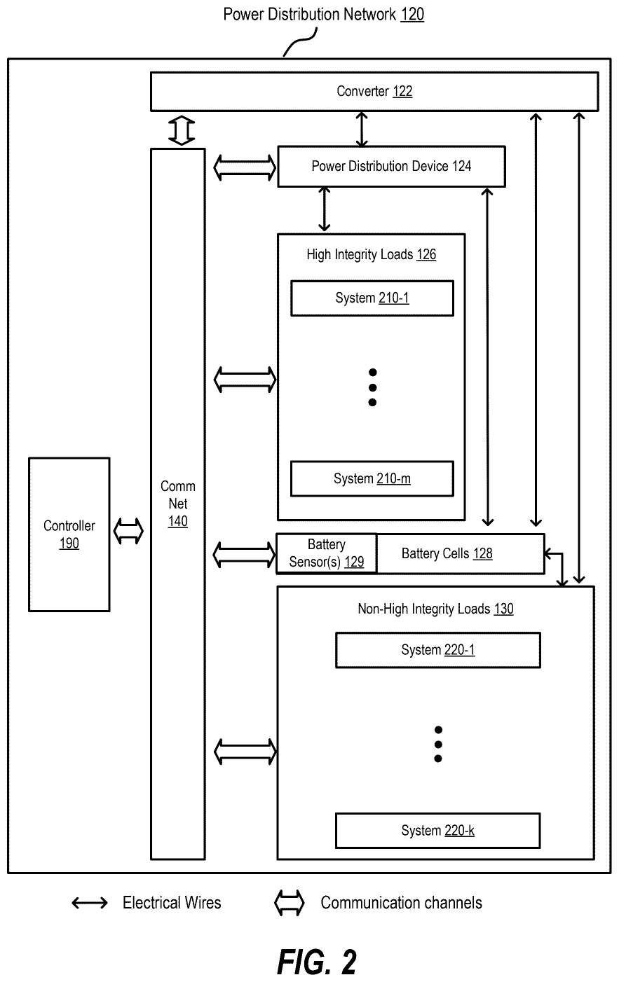

FIG. 2 is a block diagram of the power distribution network 120 showing components of the power distribution network 120 according to various aspects of the present disclosure. The power distribution network 120 shown here may be any one of the power distribution networks 120-1 . . . 120-n (FIG. 1). Here, the plurality of high integrity loads 126 may include m systems 210-1 . . . 210-m that are used by the vehicle 100 (FIG. 1) to operate safely during an occurrence of a degradation in the electrical system 102. Here, m may be a positive integer greater than 2. Examples of the m systems 210-1 . . . 210-m include a brake system, a steering system, a visual sensor system, a virtual driver system, a fuel pump system, and/or other systems.

In one aspect, the plurality of non-high integrity load 130 may include k systems 220-1 . . . 220-k that are not necessary for the vehicle 100 to operate safely during an occurrence of a degradation. Here, k may be a positive integer. In some aspects of the current disclosure, the terms k, m, and n (FIG. 1) may be the same or different. Examples of the k systems 220-1 . . . 220-k may include one or more of a lighting system, an entertainment system, a navigation system, a heating, ventilation, and air conditioning system, and/or other systems.

In certain aspects, the battery cells 128 may include one or more batteries and/or battery cells. The battery cells 128 may include one or more battery sensors 129 configured to monitor various parameters associated with the battery cells, for example, the health, temperature, and/or charge capacity of the battery cells 128. Here, the health of the battery cells may relate to one or more of a retention capability of the battery cells, loss related to the battery cells, or other factors that impact the performance of the battery cells. The one or more battery sensors 129 may transmit battery information (e.g., health, charge capacity, temperature, etc.) to the controller 190 via the communication channels of the electrical system 102 and/or the communication network 140. The one or more battery sensors 129 may transmit the battery information in series or in parallel across the communication channels.

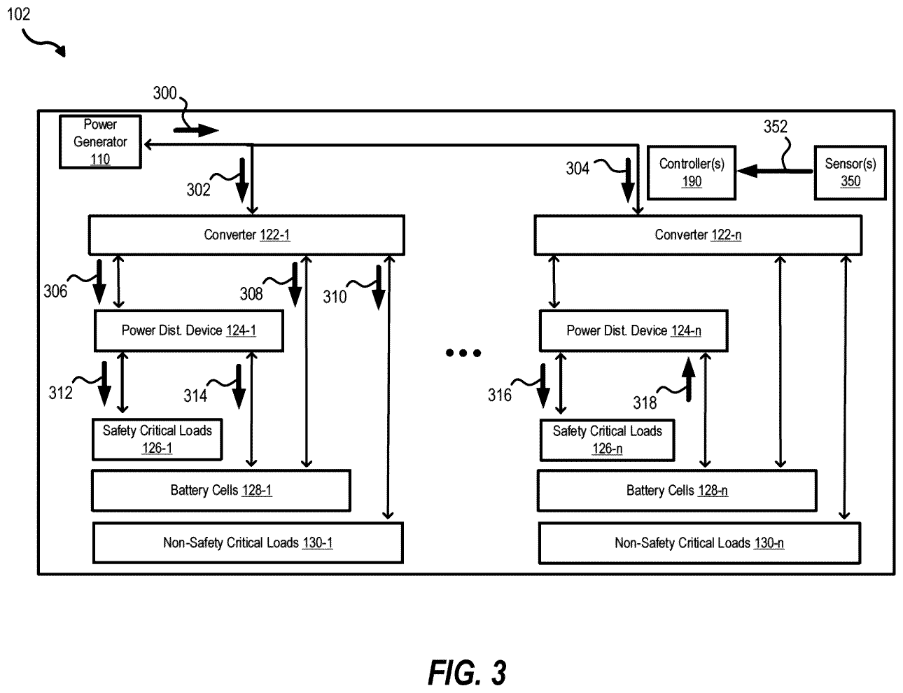

FIG. 3 is a block diagram of the electrical system 102 including indications (the bolded arrows) relating to power management and distribution, according to certain aspects of the present disclosure. In this diagram, the communication channels and the communication networks (FIG. 1) are omitted for clarity. Details relating to the indications are described below.

In some aspects, referring to FIG. 3, each of the two or more power distribution networks 120-1 . . . 120-n may receive, in parallel, at least a portion of one or more supplied currents 300 from power generator 110 via the electrical wires. In an instance, the one or more first converters 122-1 of the first power distribution network 120-1 may receive a first portion 302 of the one or more supplied currents 300 from the power generator 110. The one or more first converters 122-1 may reduce the voltages of the received first portion 302 of the one or more supplied currents 300 to a voltage sufficiently low to be used by components of the first power distribution networks 120-1. As such, the one or more first converters 122-1 may convert the first portion 302 of the one or more supplied currents 300 to currents 306, 308, 310. For example, the one or more first converters 122-1 may step the voltage of the first portion 302 of the one or more supplied currents 300, namely 48 Volts (V), down to the voltage of the currents 306, 308, 310, namely 12 V. In certain aspects, the one or more first converters 122-1 may step down the voltage of the first portion 302 of the one or more supplied currents 300 from a range of 30-60 V, 35-55 V, or 40-50V down to a range of 0-25 V, 2-20 V, or 5-18 V. Other input and/or output voltages may also be possible according to various aspects of the present disclosure.

In certain aspects, the one or more first converters 122-1 may provide the current 306 to the first power distribution device 124-1, the current 308 to the first battery cell 128-1, and the current 310 to the first plurality non-high integrity loads 130-1.

In some aspects of the present disclosure, the first power distribution device 124-1 may provide currents 312, 314 to the first plurality of high integrity loads 126-1 and/or the first battery cell 128-1, respectively.

Similarly, the one or more n^{th} converters 122-1 of the n^{th} power distribution network 120-n may receive a second portion 304 of the one or more supplied currents 300 from the power generator 110, and distribute the received portion as described above and/or according to various aspects of the present disclosure described elsewhere herein.

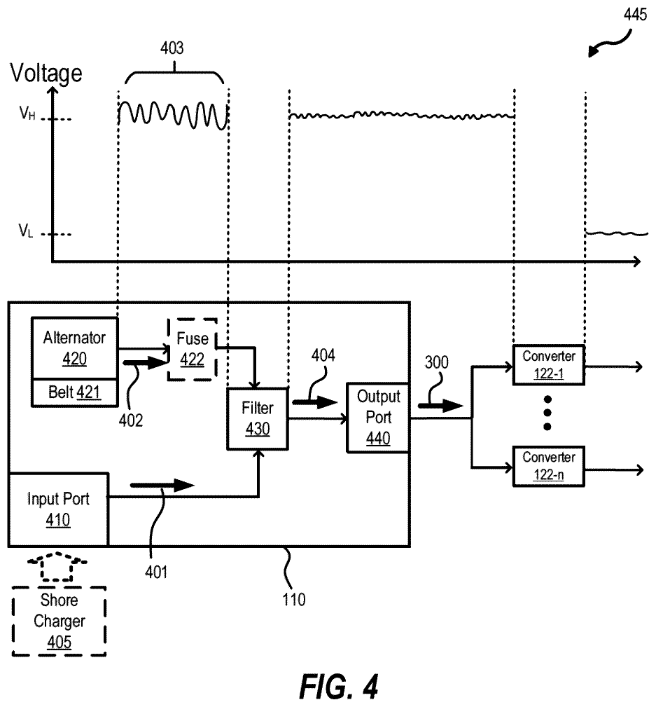

FIG. 4 is block diagram of the power generator 110 and an alternator voltage diagram 445 according to some aspects of the present disclosure. The generator 110 may provide electrical energy to the vehicle 100 (FIG. 1) via internally generated electrical current or externally provided electrical energy. In a first aspect, the power generator 110 may provide electrical energy by relying on an engine (not shown) to drive an alternator 420. In a second aspect, the power generator 110 may receive electrical current via one or more shore chargers 405, and provide the received electrical energy to the vehicle 100 as described below.

In an aspect of the present disclosure, the power generator 110 may include the alternator 420. The alternator 420 may be driven by a belt 421 (e.g., a serpentine belt and/or a timing belt) using mechanical/rotational forces from of an engine (e.g., such as a diesel engine, not shown) of the vehicle 100. The rotation of the alternative 420 may generate an AC current, which may be rectified into a DC current to be supplied to the vehicle 100. For example, the alternator 420 may include one or more rectifiers (e.g., diodes) configured to rectify the AC current generated based on the rotation of the alternator 420 into a DC current. The alternator 420 may be configured to output the rectified DC current as an alternator current 402. The power generator 110 may include an optional fuse 422 configured to control the maximum current level of the alternator current 402.

In one aspect, the power generator 110 may include a filter 430 configured to filter the input current 401 and/or the alternator current 402 into an output current 404. The filter 430 may include one or more bandpass filters, high pass filters, capacitors, inductors, resistors, or other active or passive electrical components. In one aspect, the filter 430 may include one or more capacitors having capacitance in the range of 1 microfarad (μF) to 100 millifarad (mF), or 10 μF to 10 mF, or 100 μF to 1 mF, or other suitable range depending on the electrical system 102. In some aspects, the filter 430 may be configured to filter out noises, ripples, and/or fluctuations in the input current 401 and/or the alternator current 402 to generate the output current 404. In other aspects, the filter 430 may be configured to increase the stability of the output current 404 during sudden increase and/or decrease of the electrical loads. In some aspects, the power generator 110 may include an output port 440 configured to output the output current 404 as the one or more supplied currents 300. The output port 440 may be a switch that directs portions of the output current 404 to various components of the electrical system 102, such as the to the converters 122-1 . . . 122-n of the two or more power distribution networks 120-1 . . . 120-n (FIG. 1).

In another aspect, the controllers 190-1 . . . 190-n may adjust the slew rate of the converters 122-1 . . . 122-n to increase the stability of the input/output voltages. For example, the controllers 190-1 . . . 190-n may decrease the slew rate to reduce the fluctuations. Other methods of adjustments may also be used according to aspects of the present disclosure.

In some aspects of the present disclosure, the alternator voltage diagram 445 may illustrate an example of the voltage profile from the alternator 420 to after the converters 122-1 . . . 122-n. As indicated above, the alternator 420 may generate the alternator current 402. The alternator current 402 may have a high voltage VH. For example, the high voltage VH may be 35 V, 40 V, 45 V, 48 V, 50 V, 55 V, 60 V, or other voltages. The alternator current 402 may include ripples 403 due to the effect of DC load dump. Specifically, since the alternator current 402 is not directly provided to any battery, there are no batteries to damp the ripples 403 generated by the alternator 420. The ripples 403 may be undesirable as the voltage at the “peaks” of the ripples may be too high for the electrical system 102 (FIG. 1). The filter 430 may reduce and/or remove the ripples 403. As shown in the diagram, the filter 430 may reduce and/or remove the ripples 403 to produce the output current 404. The output current 404 may have substantially the same voltage, and/or in the same voltage range, as the alternator current 402. Specifically, the output current 404 may have the high voltage VH. Subsequently, the output port 440 may provide the output current 404 as the one or more supplied currents 300 (with the ripples 403 reduced or removed) to the to the converters 122-1 . . . 122-n. Other types of fluctuations may also be filtered out by the filter 430. Examples of fluctuations may include unstable oscillations in output voltage.

In some aspects, each of the converters 122-1 . . . 122-n may step down the one or more supplied currents 300 at the high voltage VH to one or more currents (e.g., the currents 306, 308, 310 (FIG. 3)) at a low voltage VL. For example, the low voltage VL may be 12 V, 13 V, 14 V, 14.2 V, 15 V, 16 V, or other voltages.

In certain aspects of the present disclosure, one of the plurality of controllers 190-1 . . . 190-n (such as the first controller 190-1) may transmit one or more signals to the alternator 420 to set the alternator voltage of the alternator current 402 (i.e., the high voltage VH). One of the plurality of controllers 190-1 . . . 190-n may transmit one or more signals to the converters 122-1 . . . 122-n to set the voltage(s) of the currents 306, 308, 310 (i.e., the low voltage VL). In some instances, each of the converters 122-1 . . . 122-n may set the same or different voltages for the currents 306, 308, 310.

In an aspect of the present disclosure, the alternator 420 may adjust the alternator current 402 based on the load in the power distribution networks 120-1 . . . 120-n. For example, if the battery cells 128-1 . . . 128-n are fully charged, the demand for electrical current in the electrical system 102 may decrease. Since less electrical current is being sunk into the power distribution networks 120-1 . . . 120-n (due to the battery cells 128-1 . . . 128-n no longer behaving like a load), the alternative voltage of the alternative current 402 may rise, possibly above the set point by the one of the plurality of controllers 190-1 . . . 190-n indicated above. In response, the alternator 420 may reduce the alternator current 402 to react to the decrease in load.

In an aspect, and referring to FIGS. 1-4, the power generator 110 may include an input port 410 configured receive an input current 401 from an external source. For example, the input port 410 may be plugged into a single charger or multiple chargers. The one or more shore chargers 405 may be plugged into power generator 110 to supply electricity to the vehicle 100. The output voltages of the one or more shore chargers 405 may be between 0 V to 60 V, 10 V to 50 V, or 12 V to 48 V. In one aspect, the output voltages of the one or more shore chargers 405 may be 12 V, 24 V, 36 V, or 48 V. Other voltages and/or voltage ranges may also be used.

Here, a shore charger is a device or system used to supply electrical power from a land-based source (e.g., the “shore”) to a vehicle. As such, the power generator 110 may provide electrical energy to one or more components, depending on the voltage supplied by the stationary charging port, the conditions of the electrical system 102, and/or other variables. Examples of various charging operations are described below.

In some aspects, during the shore charging operations, one of the plurality of controllers 190-1 . . . 190-n may transmit signals to devices within the electrical system 102 to distribute the input current 401 to one or more components of the electrical system 102 based on the voltage of the input voltage of the input current 401 and/or the output voltage of the one or more shore chargers 405. As an example, one of the plurality of controllers 190-1 . . . 190-n may transmit signals to the converters 122-1 . . . 122-n to set the current limit of the converters 122-122-n that will be distributed to one or more components of the electrical system 102 based on the input voltage of the input current 401 (e.g., provided by the one or more shore chargers 405). Distribution is less so the control mechanism, but the amount of current that will be pulled from the charger. In one instance, one of the plurality of controllers 190-1 . . . 190-n may cause the input current 401 to be distributed to all the components in the electrical system 102. In another aspect, one of the plurality of controllers 190-1 . . . 190-n may cause the input current 401 to be distributed to all the components in a single power distribution network of the two or more power distribution networks 120-1 . . . 120-n. In other aspects, one of the plurality of controllers 190-1 . . . 190-n may cause the input current 401 to be distributed to similar components in each of the two or more power distribution networks 120-1 . . . 120-n. In yet another aspect, one of the plurality of controllers 190-1 . . . 190-n may cause the input current 401 to be distributed to a single component in a single power distribution network 120. Other power distribution schemes may also be used according to aspects of the present disclosure.

Aspects of the present disclosure may include the plurality of controllers 190-1 responding to one or more degradation events that occur in the electrical system 102 by properly supplying electrical energy to certain components to ensure the proper operation of the vehicle 100.

In a first example, a degradation may occur during a vehicle operation where the alternator 420 may be unable to output any current. Since the vehicle 100 is not being charged, the power generator 110 may be unable to supply any electrical energy to the power distribution networks 122-1 . . . 122-n. As such, one of the plurality of controllers 190-1 . . . 190-n (e.g., the first controller 190-1) may prioritize the operation of the pluralities of high integrity loads 126. Therefore, the first controller 190-1 may direct the electrical energy stored in the battery cells 128 toward the corresponding plurality of high integrity loads 126. The degradation may be detected by one or more sensors in the alternator 420 and/or the power generator 110, as is described below in more detail.

In some aspects, the first controller 190-1 may isolate the power distribution networks 120 from the power generator 110 and/or each other. For example, the controller 190 may open (and/or send signals to instruct) one or more switches to isolate the power distribution networks 120. Additionally or alternatively, the controller 190 may disconnect the electrical connectivity between the battery cells 128 of each power distribution network 120 from the corresponding plurality of non-high integrity loads 130. For example, the first controller-1 190 may open (and/or send signals to instruct) one or more switches to isolate the corresponding plurality of non-high integrity loads 130. As such, the first controller 190 may direct the electrical energy stored in the battery cells 128 toward the corresponding plurality of high integrity loads 126.

In one example, the first controller 190-1 may transmit one or more signals over the communication networks and/or communication channels to the power distribution device 124-n of the n^{th} power distribution network 120 to cause the stored current 318 in the n^{th} battery cell 128-n to flow toward the n^{th} power distribution network 120. Next, the first controller 190-1 may transmit one or more signals to the n^{th} power distribution device 124-n may re-direct the stored current 318 as the internally supplied current 316 toward the n^{th} plurality of high integrity loads 126-n. As such, the n^{th} plurality of high integrity loads 126-n may ensure the proper operation of the vehicle 100.

In an aspect, the controller 190 may isolate the defective component and/or the backup component in the electrical system 102 In the example above, the controller 190 may utilize the n^{th} power distribution device 124-n to isolate the n^{th} plurality of high integrity loads 126-n and the n^{th} battery cell 128-n from the remaining portion of the electrical system 102. For example, the controller 190 may identify the defective component, and transmit one or more signals to switches “surrounding” the defective component to toggle to the open position to electrically isolate the defective component. As such, any degradation in the rest of the electrical system 102 may not impact the operation of the backup system.

In a second example, a degradation may occur during of a vehicle operation where the first power distribution network 120-1 and its subcomponents may fail. As such, the first plurality of high integrity loads 126-1 may be unable to provide high integrity functions to the vehicle 100 (e.g., braking, steering, pumping fuels, etc.). Further, the first controller 190-1 may be unable to perform any programmed functions. As such, the n^{th} controller 190-n may transmit one or more signals to the remaining power distribution networks (e.g., the n^{th} power distribution network 120-n) to “take over” the high integrity functions. The remaining power distribution networks may provide operational redundancies to the first power distribution network 120-1.

In one aspect, each the plurality of controllers 190-1 . . . 190-n may be implemented as multiple distributed ECUs across the corresponding power distribution network 120 of the electrical system 102. The distributed ECUs of the plurality of controllers 190-1 . . . 190-n may be integrated with one or more of the power generator 110, the converters 122-1 . . . 122-n, the power distribution devices 124-1 . . . 124-n, the battery cells 128-1 . . . 128-n, the pluralities of high integrity loads 126-1 . . . 126-n, and/or the pluralities of non-high integrity loads 130-1 . . . 130-n. Further, the distributed ECUs may be integrated in subcomponents of the components described above. Other configurations for the plurality of controllers 190-1 may also be implemented according to various aspects of the present disclosure.

By implementing the distributed configuration for each of the plurality of controllers 190-1 . . . 190-n, the probability for a “complete” degradation of the plurality of controllers 190-1 . . . 190-n is reduced. Specifically, the probability for the plurality of controller 190-1 . . . 190-n be part of the degradation and/or be unable to trigger backup high integrity functions is diminished. Specifically, if one of the plurality of controllers 190-1 . . . 190-n is not operational, another one of the plurality of controllers 190-1 . . . 190-n may take over.

In one aspect of the present disclosure, each of the power distribution devices 124-1 . . . 124-n may include a power distribution ECU. Each power distribution ECU may be configured to operate on the electrical energy from a corresponding battery cell of the battery cells 128-1 . . . 128-n. Each power distribution ECU may be configured to manage the power distribution and/or usage of the corresponding power distribution network. Each power distribution ECU may be interconnected with the remaining power distribution ECUs via backup communication channels and/or backup communication networks. These backup communication channels and/or networks may be different than the communication channels and networks described above with respect to FIGS. 1 and 2. As such, if a network fails, the power distribution ECUs may rely on the “back-up” network to maintain communications among the power distribution ECUs. In one example, each of the plurality of controllers 190-1 . . . 190-n may include multiple ECUs, and a power distribution ECU associated with the first power distribution device 124-1 may transmit a status signal indicating a degradation of the first power distribution device 124-1, or fail to transmit a scheduled status signal indicating no degradation at the first power distribution device 124-1, to the n^{th} power distribution device 124-n. As a result, the n^{th} power distribution device 124-n may detect a degradation in the first power distribution device 124-1, and take one or more corrective actions as describe above.

In certain aspects, each of the plurality of controllers 190-1 . . . 190-n may detect one or more degradations by receiving, or failing to receive, sensor feedback information 352 from one or more sensors 350. The one or more sensors 350 may include electrical, mechanical, gyroscopic, optical, acoustic, and/or other types of sensors configured to detect degradations and/or abnormalities associated with various components of the vehicle 100. In other aspects, each of the plurality of controllers 190-1 . . . 190-n may detect one or more degradations by receiving and/or failing to receive one or more status signal from one or more ECUs.

In an aspect, sensors 350 may be removably or fixedly installed within the vehicle and may be disposed in various arrangements to provide information to the autonomous operation features. The sensors 350 may include, but are not limited to, one or more of a GPS unit, a radar unit, a LIDAR unit, an ultrasonic sensor, an infrared sensor, an inductance sensor, a camera, an accelerometer, a tachometer, or a speedometer. Some of the sensors 350 (e.g., radar, LIDAR, or camera units) may actively or passively scan the vehicle environment for obstacles (e.g., other vehicles, buildings, pedestrians, etc.), roadways, lane markings, signs, or signals. Other sensors 350 (e.g., GPS, accelerometer, or tachometer units) may provide data for determining the location or movement of the vehicle (e.g., via GPS coordinates, dead reckoning, wireless signal triangulation, etc.).

In some aspects, for example, the vehicle 100 may be a vehicle, an electric vehicle, a hybrid vehicle, an semi-autonomous vehicle (a vehicle that operates autonomously, but can be overridden by a human operator), a fully autonomous vehicle (a vehicle that operates autonomously, and cannot be overridden by a human operator), an autonomous car, an autonomous bus, or an autonomous truck, a freight truck, a goods carrier, a class eight truck, a heavy-duty truck, a fleet truck, or a flatbed truck. The vehicle 100 may be configured to operate in an autonomous mode, e.g., without having a human driver controlling the vehicle 100.

In an aspect of the present disclosure, the vehicle 100 may be designed to comply with the ISO standards to provide an operational system with no single point of degradation (e.g., degradation above a predetermined threshold) with an autonomous driving system (ADS) or a self-driving system (SDS). This may be achieved by controlling each component within the vehicle 100 from the ADS/SDS, providing continuous degradation monitoring, and/or reporting to the ADS/SDS. As used herein, “Automated Driving System (ADS)” or “Self-Driving System (SDS)” refers to a completely automated driving system or at least a level 4 autonomous system enabling vehicles to navigate and operate without human input. ADS or SDS operates based on collecting data from sensors such as, but not limited to, cameras, radar, and lidar to perceive their surroundings and build a real-time picture of the road, including other vehicles, pedestrians, traffic lights, and lane markings. The ADS/SDS may include a software based controller such as, not limited to an autonomous driving computer (ADC) for processing the sensor data to make navigation decisions on the road considering factors like traffic rules, road signs, and objects detected around the vehicle. The software controller also uses a detailed high-resolution map to enable the vehicle to localize itself and plan its route.

In certain aspects, the vehicle 100 may be a petrol fueled vehicle, and/or include an internal combustion engine as a propulsion system, an associated power train, and/or power transmission. In some aspects, the vehicle 100 may be a diesel fueled vehicle with an internal combustion engine and a diesel power train. For example, the vehicle 100 may include a Detroit® diesel engine with a Detroit® power train having a Detroit® power transmission. In another aspect, the vehicle 100 may be a vehicle with an electric power train. In alternative aspects, the vehicle may be propelled by hydrogen (e.g., H2 internal combustion engine, fuel cell electric vehicle (FCEV), etc.).

In a further aspect, the vehicle 100 may be any combination of an electric-powered vehicle, a petrol-powered vehicle, a diesel-powered vehicle, and/or a hydrogen-powered vehicle.

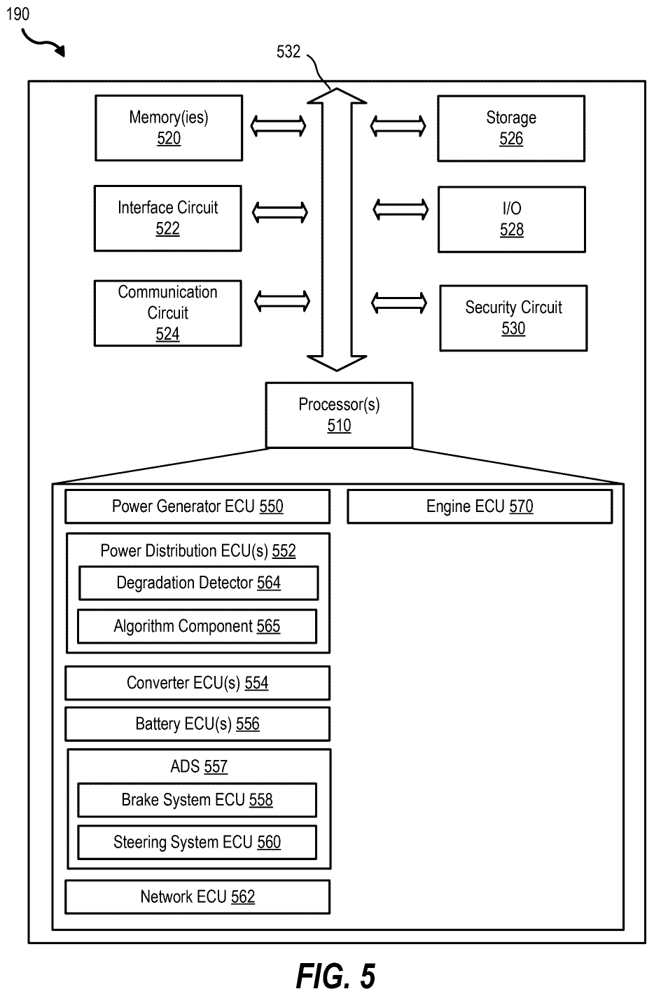

FIG. 5 illustrates an example of the controller 190 according to various aspects of the present disclosure. The controller 190 may be in a single package or as a chip set assembly with multiple components. The controller 190 may be implemented as a single integrated circuit device, or a number of distributed circuit devices. In one aspect, the controller 190 may include one or more processors 510 configured to execute instructions stored in one or more memories 520. The one or more memories 520 may include computer executable instructions that implement various functions of the current disclosure.

The term “processor” as used herein can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FcRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims.

The controller 190 may include an interface circuit 522 configured to provide a hardware interface with external devices. The controller 190 may include a communication circuit 524 configured to communicate via wired or wireless communication channels. The controller 190 may include a storage 526 configured to store digital information. The controller 190 may include an input/output (I/O) interface device 528 configured to receive input signals and/or transmit output signals. The controller 190 may include a security circuit 530 configured to authenticate an identity, authenticate a token, manage security keys, encryption keys, and/or decryption keys, encrypt data, and/or decrypt data according to aspects of the present disclosure.

In one aspect, the security circuit 530 may receive a security token (not shown) from an external device. The security circuit 530 may determine whether the external device is a trusted device by authenticating the security token. If authenticated, the security circuit 530 may grant the external device one or more of read privilege (the external device is able to read data in the storage 526), write privilege (the external device is able to modify data in the storage 526 and/or update firmware in the one or more memories 520), or both. The controller 190 may include a bus 532 configured to provide connections among the subcomponents of the controller 190.

In one aspect of the present disclosure, the one or more processors 510 may execute instructions stored in the one or more memories 520 to implement a power generator ECU 550. The power generator ECU 550 may be configured to perform the functions of the power generator 110 described above.

In one aspect of the present disclosure, the one or more processors 510 may execute instructions stored in the one or more memories 520 to implement one or more power distribution ECUs 552. The one or more power distribution ECUs 552 may be configured to the perform functions of the power distribution devices 124 described above.

In one aspect of the present disclosure, the one or more processors 510 may execute instructions stored in the one or more memories 520 to implement one or more converter ECUs 554. The one or more converter ECUs 554 may be configured to perform the functions of the converters 122 described above.

In one aspect of the present disclosure, the one or more processors 510 may execute instructions stored in the one or more memories 520 to implement one or more battery ECUs 556. The one or more battery ECUs 556 may be configured to the perform functions for managing the battery cells 128 as described above.

In certain aspects of the present disclosure, the one or more processors 510 may execute instructions stored in the one or more memories 520 to implement one or more ADS 557. The ADS may include the one or more brake system ECUs 558 and/or the one or more steering system ECUs 560. The ADS 557 may be configured to operate, autonomously and/or semi-autonomously, the vehicle 100. In some instances, the ADS 557 may include other ECUs for the operation of the vehicle 100 (e.g., lidar, sensors, virtual drivers, etc.).

In one aspect of the present disclosure, the one or more processors 510 may execute instructions stored in the one or more memories 520 to implement one or more brake system ECUs 558. The one or more brake system ECUs 558 may be configured to the perform functions associated with controlling the backup braking system.

In one aspect of the present disclosure, the one or more processors 510 may execute instructions stored in the one or more memories 520 to implement one or more steering system ECUs 560. The one or more steering system ECUs 560 may be configured to the perform functions for controlling the backup steering system.

In one aspect of the present disclosure, the one or more processors 510 may execute instructions stored in the one or more memories 520 to implement one or more network ECUs 562. The one or more network ECUs 562 may be configured to the perform functions for managing the communication networks 140-1 . . . 140-n as described above.

In certain aspects of the present disclosure, the one or more processors 510 may execute instructions stored in the one or more memories 520 to implement one or more degradation detectors 564. The one or more degradation detectors 564 may be configured to identify one or more degradations in the electrical system 102, determining a countermeasure in response to identifying the one or more degradations, and/or providing an indication of the one or more degradations. Here, the one or more degradation detectors 564 are shown as a part of the one or more power distribution ECUs 552. However, the one or more degradation detectors 564 may be implemented differently according to various aspects of the present disclosure.

In a certain aspect of the present disclosure, the one or more degradation detectors 564 may be configured to detect a belt slip associated with the alternator 420 as described below.

In one aspect of the present disclosure, the one or more processors 510 may execute instructions stored in the one or more memories 520 to implement an algorithm component 565. The algorithm component 565 may be configured to compute a slip value as described below. Here, the algorithm component 565 is shown as a part of the one or more power distribution ECUs 552. However, the algorithm component 565 may be implemented differently according to various aspects of the present disclosure.

In one aspect of the present disclosure, the one or more processors 510 may execute instructions stored in the one or more memories 520 to implement an engine ECU 570. The engine ECU 570 may be configured to output performance variables associated with an engine (discussed below) of the vehicle. Example performance variables include engine speed (e.g., measured in rotations per minute (RPM)), temperature, alarm, or other suitable metrics associated with the engine.

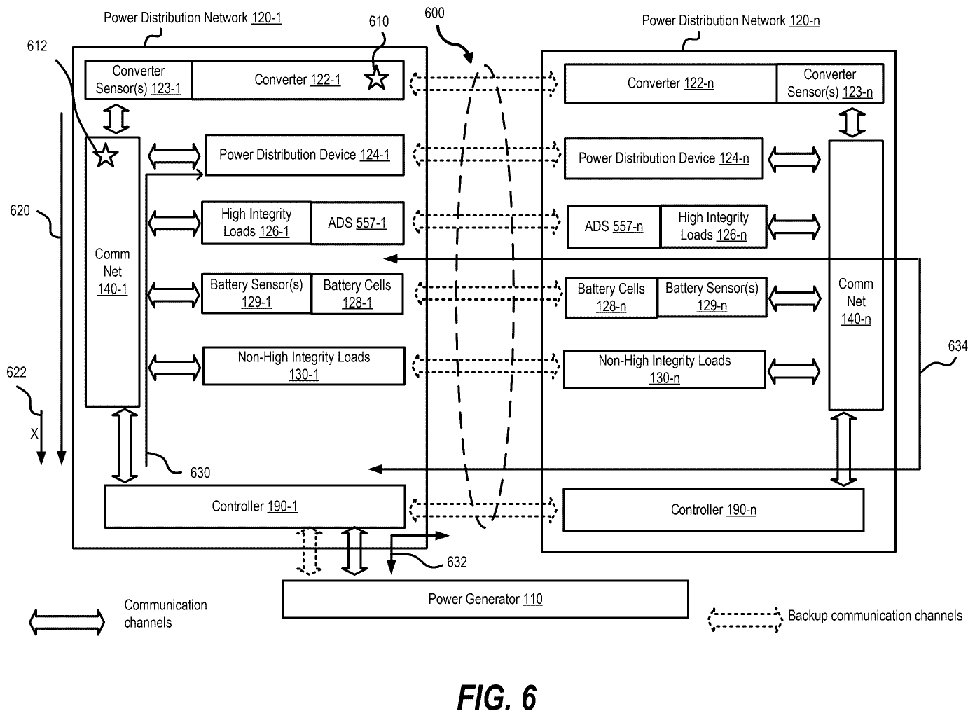

FIG. 6 is a block diagram showing communication networks in the electrical system 102 of the autonomous vehicle 100 and different signals according to various aspects of the present disclosure. In FIG. 6, a single power distribution network is shown for simplicity but one or more power distribution networks 120 may be implemented. Here, the controller 190 may communicate with the components of the power distribution network 120 via the communication network 140 and/or the communication channels. In some aspects, in response to one or more degradations in the communication network 140 and/or the communication channels, the controller 190 may communicate with the power distribution network 120 and/or the power generator 110 via the backup communication network 600 and/or the backup communication channels.

In certain aspects of the present disclosure, a degradation 610 may occur in the converter 122. One or more converter sensors 123 may detect the degradation 610 in the converter 122. For example, the one or more converter sensors 123 may detect an open circuit in the converter 122. As a result, the converter 122 may be unable to properly supply electrical energy to the components of the power distribution network 120. The one or more sensors 123 may transmit a degradation indication signal 620 via the communication network 140 to the controller 190 indicating the degradation 610. Upon receiving the degradation indication signal 620, the controller 190 may identify a degradation, such as the degradation 610, in the converter 122. In response to the degradation 610 in the converter 122 (as indicated by the degradation indication signal 620), the controller 190 may transmit a degradation response signal 630 to the power distribution device 124. The degradation response signal 630 may indicate to the power distribution device 124 that the converter 122 is inoperable. In response to the degradation response signal 630, the power distribution device 124 may direct the electrical energy in the battery cells 128 to the high integrity loads 126 to ensure the proper operation of the vehicle 100.

In another aspect of the present disclosure, a degradation 612 may occur in the communication network 140. As a result, the communication network 140 may fail to transmit periodic status signals 622 to the controller 190. The periodic status signals 622 may be a plurality of signals that are transmitted periodically by the communication network 140 to the controller 190 indicating the proper operation of the communication network 140. If the controller 190 is receiving the periodic status signals 622, the controller 190 will assume that the communication network 140 is operating properly. If the controller 190 fails to receive one or more of the periodic status signals 622, the controller 190 will assume that the communication network 140 has experienced a degradation, such as the degradation 612.

As a result of failing to receive one or more of the periodic status signals 622, the controller 190 may identify a degradation, such as the degradation 612, in the communication network 140. In response, the controller 190 may transmit one or more degradation response signals 632 to the backup communication network 600, the power generator 110, and/or components of the power distribution network 120. The one or more degradation response signals 632 may indicate to the backup communication network 600, the power generator 110, and/or components of the power distribution network 120 that the communication network 140 has degraded due to the degradation 612. As such, the backup communication network 600 may be used for communication.

In certain aspects of the present disclosure, the controller 190 may provide an indication (such as displaying a warning light) to the operator (not shown) of the vehicle 100 in response to the detection of a degradation, such as the degradations 610, 612. Additionally, the indication (or a related indication) provided by the controller 190 may indicate the type of degradation.

In one aspect of the present disclosure, the degradation 612 in the communication network 140-1 may prevent the controller 190-1 from communicating (e.g., transmitting or receiving a signal) with the ADS 557-1 associated with the high integrity loads 126-1. In response to the degradation 612, the controller 190-1 may communicate with the ADS 557-1 via a backup path 634. For example, the controller 190-1 may transmit one or more signals to the controller 190-n, which relays the one or more signals to the ADS 557-n. The ADS 557-n may relay the one or more signals to the ADS 557-1 via the backup communication network 600 and/or the backup communication channels.

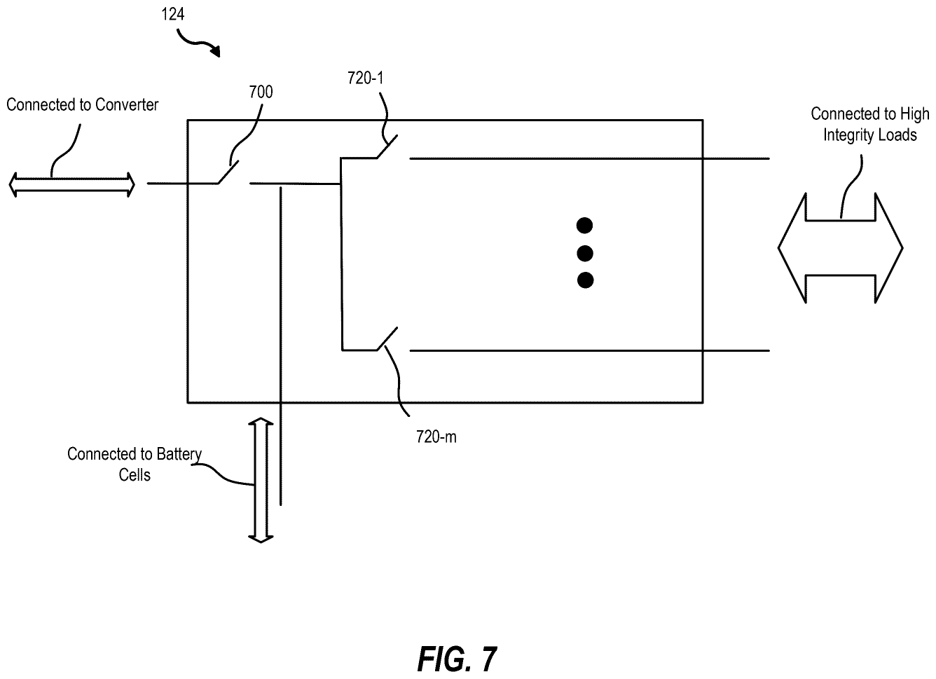

FIG. 7 is a block diagram of a power distribution device 124 according to aspects of the present disclosure. Referring to FIGS. 1-4, 7, and 5, in some aspects, electrical energy from the power generator 110 may be supplied to the converter 122, and through a switch 700, supplied to the power distribution device 124. The controller 190 may close the switch 700 of the power distribution device 124 to enable the power distribution device 124 to receive the electrical energy from the converter 122, such as in the form of the one or more supplied currents. In one aspect, the controller 190 may close the switch 700 to supply a portion of the electrical energy to the battery cells 128 and/to charge the battery cells 128. In other aspects, the controller 190 may close a plurality of switches 720-1 . . . 720-m to supply another portion of the electrical energy to the high integrity loads 126. Here, each of the plurality of switches 720-1 . . . 720-m may control the flow of electricity between the converter 122 and/or the battery cells 128 to a corresponding system of the systems 210-1 . . . 210-m in the high integrity loads 126.

In some aspects, the controller 190 may detect a degradation, such as the degradation 610 associated with the converter 122. To isolate the high integrity loads 126 and the battery cells 128, the controller 190 may open the switch 700 and close the plurality of switches 720-1 . . . 720-m to direct the electrical energy stored in the battery cells 128 to the high integrity loads 126. Further, opening the switch 700 may isolate the battery cells 128 from components other than the high integrity loads 126. As such, this scheme prevents the electrical energy stored in the battery cells 128 from “leaking” charges. Additionally or alternatively, opening the switch 700 may prevent the battery cells 128 and the high integrity loads 126 from being exposed to the degradation.

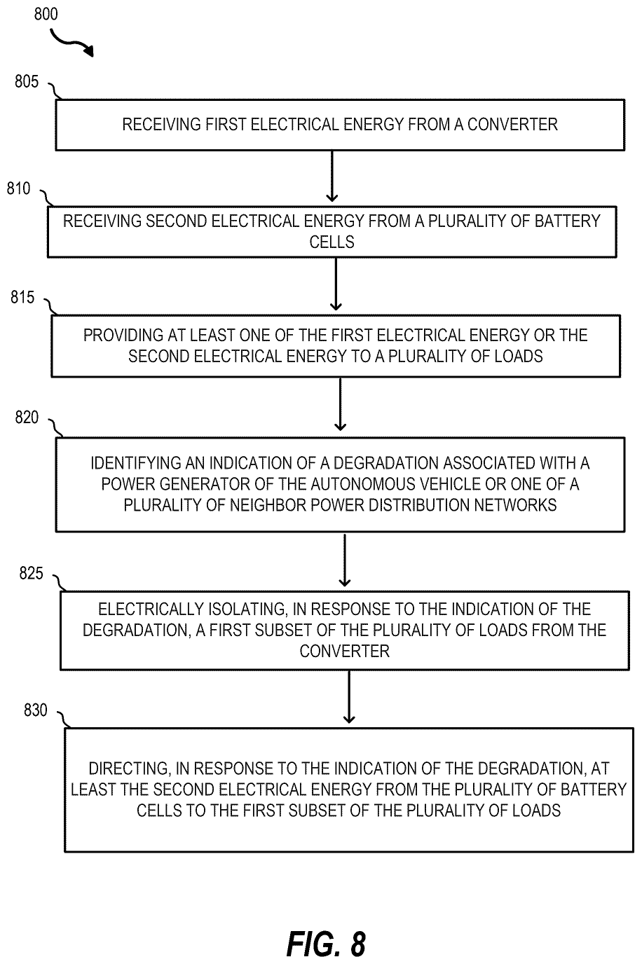

FIG. 8 is a flow chart showing a method 1100 for operating a power distribution device, such as in the vehicle 100, according to aspects of the present disclosure. The method 1100 may be performed by one or more of the power distribution devices 124-1 . . . 124-n, one or more of the plurality of controllers 190-1 . . . 190-n, and/or components of the one or more of the plurality of controllers 190-1 . . . 190-n.

At 805, the method 800 may include receiving first electrical energy from a converter. For example, as described in detail above, the power distribution device 124 may be configured to, and/or provide means for, receiving first electrical energy (e.g., the current 306) from the converter 122.

At 810, the method 800 may include receiving second electrical energy from a plurality of battery cells. For example, as described in detail above, the power distribution device 124 may be configured to, and/or provide means for, receiving second electrical energy (e.g., stored current 318) from a plurality of battery cells 128.

At 815, the method 800 may include providing at least one of the first electrical energy or the second electrical energy to a plurality of loads. For example, as described in detail above, the power distribution device 124 may be configured to, and/or provide means for, providing at least one of the first electrical energy (e.g., current 306) or the second electrical energy (e.g., the stored current 318) to a plurality of loads (e.g., the high integrity loads 126 and/or the non-high integrity loads 130).

At 820, the method 800 may include identifying an indication of a degradation associated with a power generator of the autonomous vehicle or one of a plurality of neighbor power distribution networks. For example, as described in detail above, the power distribution device 124 may be configured to, and/or provide means for, identifying an indication (e.g., the degradation indication signal 620 and/or failing to receive the periodic status signals 622) of a degradation (e.g., the degradations 610, 612) associated with a power generator 80 of the autonomous vehicle 100 or one of a plurality of neighbor power distribution networks 120-1 to 120-n. In one example, the power distribution ECU 552, the degradation detector 564, the controller 190, and/or the power distribution device 124 may receive the degradation indication signal 620 and/or failing to receive the periodic status signals 622. As such, the power distribution ECU 552, the degradation detector 564, the controller 190, and/or the power distribution device 124 may identify the degradations 610, 612.

At 825, the method 800 may include electrically isolating, in response to the indication of the degradation, a first subset of the plurality of loads from the converter. For example, as described in detail above, the power distribution device 124 may be configured to, and/or provide means for, electrically isolating (e.g., via the switch 700), in response to the indication (e.g., the degradation indication signal 620 and/or failing to receive the periodic status signals 622) of the degradation (e.g., the degradations 610, 612), a first subset of the plurality of loads (e.g., one or more of the systems 210-1 . . . 210-m of the high integrity loads 126) from the converter (e.g., the converter 122). In one example, the power distribution ECU 552, the degradation detector 564, the controller 190, and/or the power distribution device 124 may open the switch 700 to isolate the ono or more of the systems 210-1 . . . 210-m from the converter 122.

At 830, the method 800 may include directing, in response to the indication of the degradation, at least the second electrical energy from the plurality of battery cells to the first subset of the plurality of loads. For example, as described in detail above, the power distribution device 124 may be configured to, and/or provide means for, directing (e.g., by opening the switch 700 and closing the plurality of switches 720-1 . . . 720-m), in response to the indication of the degradation, at least the second electrical energy (e.g., stored current 318) from the plurality of battery cells 128 to the first subset of the plurality of loads (e.g., at least one of the high integrity loads 126). In one example, the power distribution ECU 552, the degradation detector 564, the controller 190, and/or the power distribution device 124 may close the plurality of switches 720-1 . . . 720-m to direct the stored current 318 from the battery cells 128 to the high integrity loads 126.

Aspects of the present disclosure include a method for operating a power distribution device during a degradation including receiving first electrical energy from a converter, receiving second electrical energy from a plurality of battery cells, providing at least one of the first electrical energy or the second electrical energy to a plurality of loads, identifying an indication of a degradation associated with a power generator of the autonomous vehicle or one of a plurality of neighbor power distribution networks, electrically isolating, in response to the indication of the degradation, a first subset of the plurality of loads from the converter, and directing, in response to the indication of the degradation, at least the second electrical energy from the plurality of battery cells to the first subset of the plurality of loads.

Aspects of the present disclosure include the method above, further comprising suspending supply of the second electrical energy to a second subset of the plurality of loads.

Aspects of the present disclosure include any of the methods above, wherein the first subset of the plurality of loads includes high integrity loads and the second subset of the plurality of loads includes non-high integrity loads.

Aspects of the present disclosure include any of the methods above, wherein the power generator comprises an alternator configured to output an alternator current and a filter configured to filter the alternator current to generate an output current to provide the first electrical energy.

Aspects of the present disclosure include any of the methods above, wherein the second voltage is lower than the first voltage.

Aspects of the present disclosure include any of the methods above, wherein each of the plurality of power distribution networks further comprises a communication network configured to provide one or more communication channels for receiving the indication of the degradation.

Aspects of the present disclosure include any of the methods above, wherein the power distribution device comprises a plurality of sensors, wherein at least one of the plurality of sensors is configured to detect the degradation.

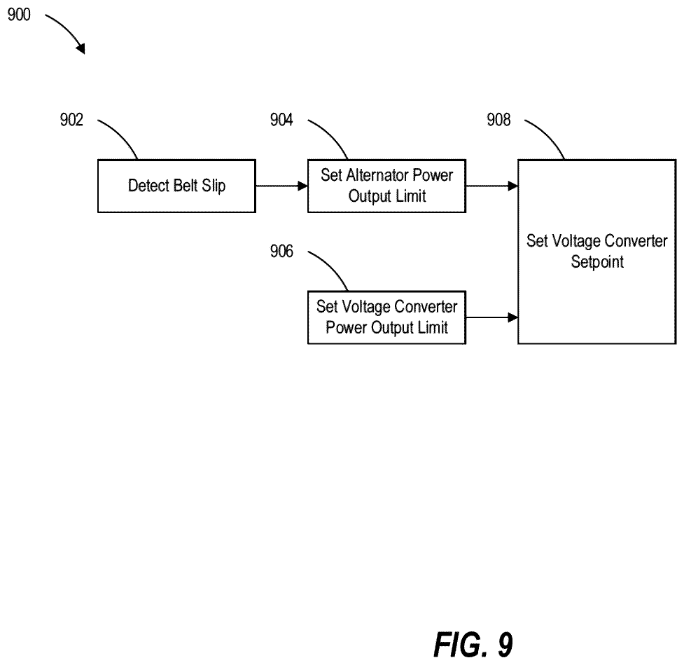

FIG. 9 is a flow chart illustrating a method 900 of managing the distribution of electrical power within a vehicle (for example, the vehicle 100) according to an example. In some examples, and referring to FIGS. 1, 4, 5, and 9, the method 900 may be performed by the one or more processors 510, the one or more memories 520, the one or more degradation detector 564, and/or the algorithm component 565. Here, the method 900 may be applied to any system that includes an engine, an alternator driven by the engine, and/or at least one voltage converter connected to the alternator according to various aspects of the present disclosure. In the current example, the electrical system 102 may include three power distribution networks (120-1, 120-2, 120-3) each with one or more components as illustrated in FIG. 1 above. However, aspects of the present disclosure include the electrical system 102 with different numbers of power distribution networks, such as 1, 2, 3, 5, 10, or more.

At 902, the method 900 may include detecting a slippage (“belt slippage”) of the belt 421 of the alternator 420 of the vehicle 100. Examples of the belt may include The belt of the vehicle 100 can be connected to or hung from a pulley of an alternator (for example, the alternator 420) of the vehicle 100 and a pulley of the engine of the vehicle 100.

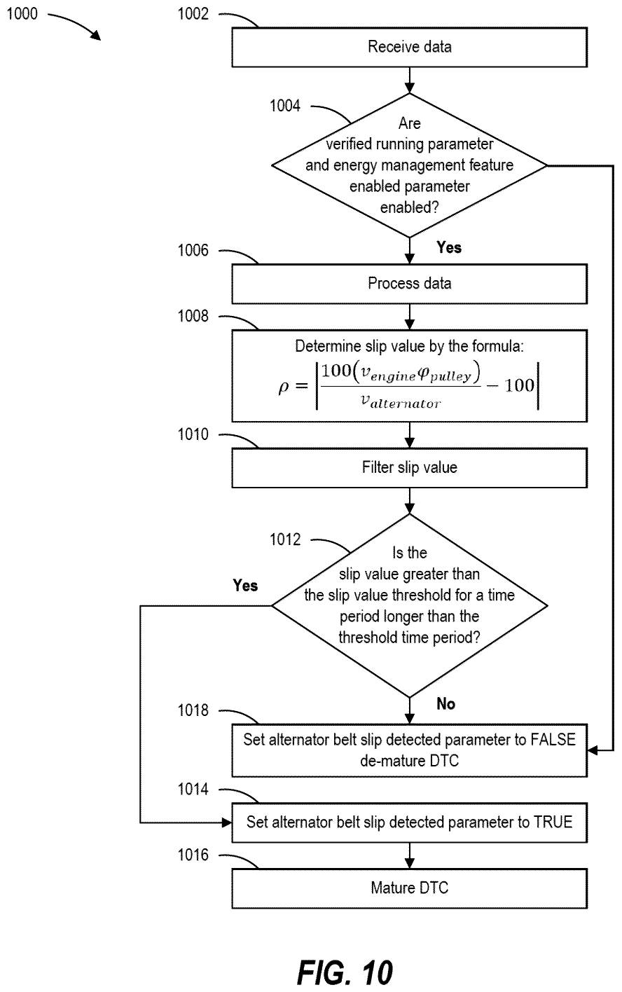

An aspect of the step 902 may further include receiving data, such as an engine speed, an alternator speed, and/or a pulley ratio as described below. The pulley ratio may be a ratio of the size of a pulley coupled to the engine (not shown) and the size of a pulley coupled to the alternator 420. Another aspect of the step 902 may further include calculating, based on the received data, a slip value (which is also referred to herein as a “slip percent value” or a “slip percent”) that qualifies and/or quantifies the amount of belt slippage. In some examples, the slip value may be given by Equation 1, which is presented below with reference to FIG. 10. Belt slip may be detected at step 902 if the slip value exceeds a slip value threshold. In some examples, belt slip may be detected if the slip value exceeds the slip value threshold for a time period longer than a threshold time period. Further examples of the step 902 are described with respect to the flow chart of FIG. 10 showing the method 1000.

At step 904, the method 900 may include setting a power output limit of the alternator 420. An aspect of the step 904 may include receiving data, such as a power output of the alternator 420 and/or a power capability of the alternator 420. The power output of the alternator 420 may be decreased from an initial power output limit (which may be the default power output limit, a nominal power output limit, or other output limits) to a reduced power output limit (e.g., a minimal power output limit) if one or more of the following conditions is met: (1) the power output of the alternator 420 is greater than an allowable power output limit, (2) active belt slip is detected at step 902, or (3) the power output of the alternator 420 exceeds the power capability of the alternator 420. In some aspects, the power output limit of the alternator 420 may be “set” by reducing the voltage setpoint of the converters 122.

In some aspects, the minimum power output limit is the amount of electrical power required to power the electrical load connected to the alternator 420. In some examples, the minimum power output limit may be calculated from the sum of one or more of the following: (1) the difference between the electrical power consumed by the electrical load of the first power distribution network 120-1 and the amount of power provided by the first battery cell 128-1, (2) the difference between the electrical power consumed by the electrical load of the second power distribution network 120 and the amount of power provided by the second battery cell 128-2, and/or (3) the difference between the electrical power consumed by the electrical load of the third power distribution network and the amount of power provided by the third battery pack (not shown). As such, the battery cells 128-1, 128-2 may provide energy to the power distribution networks 120 in situations where the power output of the alternator 420 has been reduced.

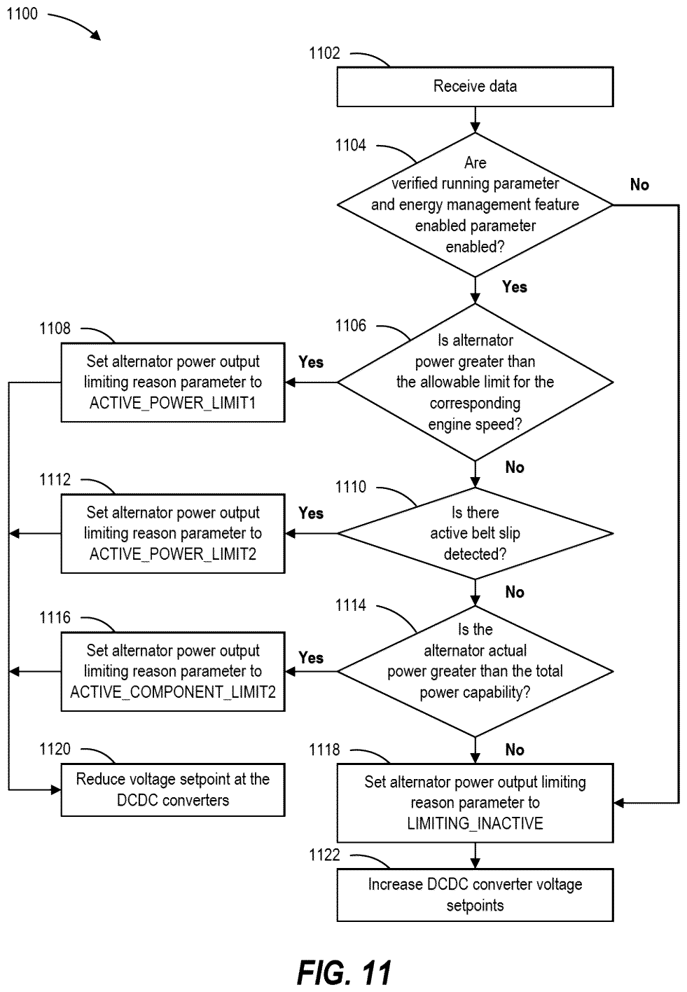

Other aspects of the step 904 may further include setting an alternator power output limiting parameter to a value indicating that the alternator power output should be limited. Further examples of the step 904 are described with respect to the flow chart showing the method 1100 of FIG. 11.

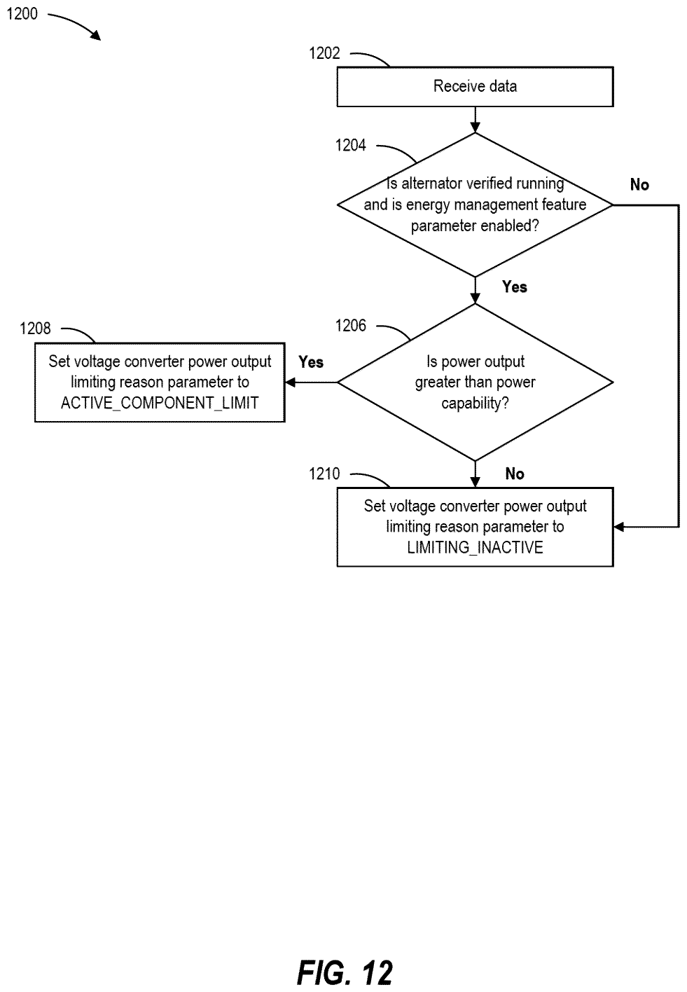

At step 906, the method 900 may include setting a power output limiting reason parameter of a voltage converter (for example, any combination of the converters 122-1, 122-2, 122-3). In certain instances, the step 906 may be repeated for each of the converters 122-1, 122-2, 122-3. In other aspects, the step 906 may include receiving data, such as a power output of each of the converters 122-1, 122-2, 122-3 and/or a power capability of each of the converters 122-1, 122-2, 122-3. If the power output is greater than the power capability, the power output limiting reason parameter may be set to a value that indicates the power output of the converters 122-1, 122-2, 122-3 should be limited. Further examples of the step 906 are described with respect to the flow chart 1200 of FIG. 12.

At step 908, the method 900 may include setting a voltage setpoint of one or more of the converters 122-1, 122-2, 122-3. The voltage setpoint may be set to a minimum voltage setpoint if at least one of the alternator power output limiting parameter and/or the converter power output limiting reason parameter are enabled (i.e., set to a value indicating that power should be limited). The minimum voltage setpoint may be the minimum voltage required to power the components connected to the alternator 420. For example, if a converter of the converters 122-1, 122-2, 122-3 is configured to provide a 12-volt supply voltage, the minimum voltage setpoint may be less than 14 volts, less than 13.6 volts, less than 13 volts, less than 12.6 volts, less than 12 volts, less than 11.5 volts, or other values or ranges. In some aspects, the step 908 may further include generating a command to instruct the converter ECU 554 to decrease the converter setpoint. Further examples of the step 908 are described below.

FIG. 10 is a flow chart illustrating a method 1000 of detecting a slippage (“belt slippage”) of the belt 421 of the vehicle 100 according to some aspects of the present disclosure. In some examples, and referring to FIGS. 1, 4, 5, and 10, the method 1000 may be performed by the one or more processors 510, the one or more memories 520, the one or more degradation detector 564, and/or the algorithm component 565. The belt 421 of the vehicle 100 may be coupled to or hung from a pulley of an alternator (for example, the alternator 420) of the vehicle 100 and a pulley of the engine (not shown) of the vehicle 100. In some aspects, the method 1000 illustrated by the flow chart may be performed as part of the method 900 illustrated by the flow chart in FIG. 9. In one aspect of the present disclosure, the method 1000 may be performed as part of, or in lieu of, step 902 (FIG. 9).

At step 1002, the method 1000 may include receiving data, such as an engine speed (e.g., denoted as aEngSpd_Cval) of the engine, an alternator speed (e.g., denoted as aAlt_RPM_Cval) of the alternator 420, and a pulley ratio (e.g., denoted as AltEngSpdRatio) of the belt 421 coupled to the engine and to the alternator 420. The pulley ratio can be a ratio of the size of a pulley coupled to the engine and the size of a pulley coupled to the alternator 420. In some aspects, the engine speed and the alternator speed may be received from the engine and the alternator 420 and/or sensors coupled to the engine and/or the alternator 420 of the vehicle 100, respectively. In some examples, this data can be measured instead of received.

In some aspects of the present disclosure, the data received at step 1002 may include a “running verified” parameter (e.g., denoted as RUNNING_VERIFIED) and an “active slip determination feature enabled” parameter (e.g., denoted as ActiveSlipDetEnabled). The running verified parameter may indicate whether an engine of the vehicle 100 is running, the alternator 420 is charging, and/or the converters 122-1, 122-2, 122-3 are operating. The active slip determination feature enabled parameter may indicate whether the vehicle 100 is operating in a mode that allows for belt slip to be detected and/or whether the belt slip detection is desired.

At step 1004, the method 1000 may include determining whether the running verified parameter and/or the energy management feature enabled parameter (described in further details below) are enabled. If one or both parameters have been determined to be enabled, the method 1000 proceeds to step 1006. Otherwise, the method 1000 proceeds to step 1018.

At step 1006, the method 1000 may include processing the received data. In some aspects of the present disclosure, the received data may be processed by synchronizing the engine speed with the alternator speed. In an aspect, the engine speed may be synchronized by offsetting the time at which the engine speed is measured by a time delay offset (e.g., denoted as EngSpdSignalOffset) to account for the time required to transfer torque from the engine to the alternator 420. In certain aspects, the time delay offset may be in a range from 10 milliseconds to 100 milliseconds, such as from 25 milliseconds to 75 milliseconds, from 40 milliseconds to 60 milliseconds, and/or approximately 50 milliseconds. Other values and/or ranges may also be possible according to various aspects of the present disclosure. As such, the synchronized engine speed (i.e., an estimated alternator speed) may be more accurately compared to the alternator speed at a subsequent step (step 1008). In some aspects, such as instances where there is little or no time delay, the engine speed is not synchronized.

In some aspects of step 1006, processing the received data may further include discarding invalid data. For example, any alternator speed, engine speed, or synchronized engine speed equaling or substantially equaling to zero may be discarded, since the alternator speed and engine speed are likely greater than zero when the vehicle 100 is running.

At step 1008, the method 1000 may include calculating a slip value (which is also referred to herein as a “slip percent value” or a “slip percent”). The slip value may a percentage or value that quantifies the amount by which the estimated alternator speed and the actual alternator speed differ. For example, the slip value may be associated with the amount by which the torque imparted on the alternator 420 by the engine exceeds the available friction between the alternator 420 and the belt. In one aspect, the slip value may be calculated by the following equation:

$${ρ}_{slip} = \vert \frac{100 ( {ω}_{engine} {φ}_{p ulley} )}{{ω}_{alternator}} - 100 \vert \qquad ( 1 )$$

wherein ρₛₗᵢₚ is the slip value, ω_{engine} is the synchronized engine speed, ωₐₗₜₑᵣₙₐₜₒᵣ is the alternator speed, and φ_{pulley} is the pulley ratio.

At step 1010, the method 1000 may include filtering the slip value. In some examples, the slip value can be filtered using an infinite impulse response (IIR) filter. Other types of filters may also be used according to various aspects of the present disclosure. In this way, noise and other transient signals may be filtered from the slip value to provide a more accurate measurement of belt slip over time. In some instances, the step 1010 may be omitted.

At step 1012, the method 1000 may include determining whether the slip value is greater than a slip value threshold (e.g., denoted as SlipDetThreshold_pct) over a threshold time period (e.g., denoted as SlipDetTimeThreshold_msec). A slip value greater than the slip value threshold may be indicative of excessive belt slippage that can impact the operation of the vehicle 100. In some aspects, the step 1012 may optionally include selecting the slip value threshold based on the measured engine speed. For example, the slip value threshold may be positively correlated with engine speed, such that higher slip value thresholds are selected for higher engine speeds. In certain aspects, the slip value threshold may be a set percentage (for example, 10%) of the measured engine speed. In other aspects, the slip value threshold may be a constant speed (for example, 10 rotations per minute (rpm)) that does not depend on the measured engine speed. In another aspect, the slip value threshold may be selected based on additional parameters, such as a diameter of the pulley coupled to the alternator 420, an engine load, an engine type and/or size, the size or width of the belt 421, and operating conditions of the engine and the alternator 420 (for example, temperature, humidity). Other methods of determining the slip value threshold may also be implemented according to various aspects of the present disclosure.

In some aspects, the slip value threshold may be obtained from a lookup table that maps one or more variables (for example, engine speeds) to slip value thresholds. The lookup table may be stored in a memory unit of the electrical system 102 or the vehicle 100 (e.g., the one or more memories 520) and may be accessed by the processor controlling the operation of the electrical system 102 (e.g., the one or more processors 510).

In certain aspects of the present disclosure, the threshold time period may be a time period spanning milliseconds, seconds, or minutes. In an aspect, the threshold time period may vary based on one or more variables (for example, engine speed, alternator speed, alternator power output, etc.). Comparing the slip value to the slip value threshold over the threshold time period may help better ensure that noise or other transient signals do not falsely register as indications of a belt slip. Further, comparing the slip value to the slip value threshold over the threshold time period may be implemented to only adjust the alternator power output in response to prolonged, repeated, and/or systemic belt slippage.

At 1014, if the slip value has been determined to be greater than the slip value threshold at step 1012, the method 1000 may further include enabling an “alternator belt slip detected” parameter (e.g., denoted as altBeltSlipDetected). In the example shown in FIG. 10, the value of the alternator belt slip detected parameter may be set to TRUE, or other suitable logical values. In certain aspects, the alternator belt slip detected parameter may be enabled only if a “power limiting enabled” parameter (e.g., denoted as SlipDetPowerLim) is also enabled. For example, disabling SlipDetPowerLim may disable the alternator belt slip detected logic and set the alternator belt slip detected parameter to a no slip detected value (e.g., denoted as NO_SLIP_DETECTED). In this way, the method 1000 may continue if the power limiting enabled parameter indicates that alternator power limiting is desired.

At 1016, the method 1000 may include maturing (in other words, generating, enabling, or activating) a diagnostic test code (DTC) that indicates belt slip has been detected. In certain aspects, the DTC (and any other DTC disclosed herein) may be configured to be received or detected by other subsystems of the vehicle 100 (for example, an onboard diagnostics system of the vehicle 100). In some examples, any of the disclosed DTCs may be configured to be received or detected by systems that are external to the vehicle 100 (for example, external servers, other vehicles, code readers). In an aspect, any of the disclosed DTCs may be displayed or otherwise communicated to an operator of the vehicle 100, for example, via a dashboard display (not shown) of the vehicle 100.

At 1018, if the slip value has been determined to not exceed the slip value threshold at step 1012, the method 1000 may include disabling or deactivating the alternator belt slip detected parameter (e.g., set the parameter to FALSE) and de-maturing (in other words, deactivating or disabling) the DTC.

FIG. 11 is a flow chart illustrating a method 1100 of setting a power output limit of an alternator (for example, the alternator 420). In some examples, and referring to FIGS. 1, 4, 5, and 11, the method 1100 may be performed by the one or more processors 510, the one or more memories 520, the power generator ECU 550, the one or more degradation detector 564, and/or the algorithm component 565. In some examples, the method 1100 illustrated by the flow chart may be performed as part of the method 900 illustrated by the flow chart in FIG. 9. Specifically, the method 1100 may be performed as part of, or in lieu, of step 904.

At 1102, the method 1100 may include receiving data. Examples of the data received at step 1102 may include one or more of a power output of the alternator 420 (e.g., denoted as aAlt_PowerAct_Cval) and/or a power capability of the alternator 420 (e.g., denoted as aAlt_TotalPowerCapability). In an aspect of the present disclosure, this data may be received from the alternator 420 and/or one or more sensors coupled to the alternator 420. In some examples, the step 1102 may include measuring or collecting the power output of the alternator 420.

In certain aspects of the present disclosure, the data received at 1102 may optionally include one or more of the running verified parameter and the “energy management feature enabled” parameter (e.g., denoted as EnergyMgmntEnabled). As discussed above, the running verified parameter may indicate whether an engine (not shown) of the vehicle 100 is running, the alternator 420 is charging, and/or the converters 122-1, 122-2, 122-3 are operating. The energy management feature enabled parameter may indicate whether the vehicle 100 is operating in a “power limiting” mode that allows for the limiting of the power output of the alternator 420, the derating of certain components of the vehicle 100, and/or the limiting of the converters 122

In some examples, the data received at step 1102 may additionally or alternatively include an “alternator energy management feature enabled” parameter (e.g., denoted as AltEnergyMgmtEnabled). The alternator energy management feature enabled parameter may indicate whether the vehicle 100 is operating in a mode that allows for the limiting of the power output of the alternator 420 and/or the derating of certain components of the vehicle 100.

In some examples, the data received at step 1102 may further include the belt slip detected parameter that was enabled or disabled in the method 1000 described with respect to FIG. 10.

At step 1104, the method 1100 may include determining whether the running verified parameter of the alternator and the energy management feature enabled parameter are enabled. If both parameters are be enabled, the method 1100 proceeds to step 1106. Otherwise, the method 1100 proceeds to step 1518.

At 1106, the method 1100 may include determining whether the power output of the alternator 420 exceeds an allowable power output limit of the alternator 420. In some aspects, the allowable power output limit may be selected based on the measured engine speed. In certain aspects, the allowable power output limit may be positively correlated with engine speed such that higher allowable power output limits are selected for higher engine speeds. In other aspects, the allowable torque output limit may be a set percentage (e.g., 5%, 10%, 15%, 20%, etc.) of a nominal or rated torque output by the engine at the measured engine speed. In an aspect, the allowable torque output limit may be a constant value of torque (e.g., 5 Newton-meters, 10 Newton-meters, 15 Newton-meters, etc.) that does not vary with engine speed. Other values of torque output limits may also be possible.

In some examples, the allowable power output limit can be a obtained from a lookup table that maps one or more variables (for example, engine speeds) to allowable power output limits. The lookup table can be stored in the memory unit of the electrical system 102 and can be accessed by the processor controlling the operation of the electrical system 102.

If the power output of the alternator exceeds the allowable power output limit, the method proceeds to step 1108, at which an alternator power output limiting parameter (e.g., denoted as altPowerLimitingActiveReason) may be set equal to a first value (e.g., denoted as ACTIVE_POWER_LIMIT1) that indicates the electrical system 102 (e.g., the converters) should be set to a power output limiting mode because the power output of the alternator 420 exceeds the allowable power output limit, and/or that power limiting is required or desired. In certain examples, the step 1108 may include maturing the DTC indicating that the power output of the alternator 420 should be limited.

At step 1106, the method 1100 may determine whether the energy management feature enabled parameter and/or the alternator energy management feature enabled parameter are disabled. If one or both of these parameters are disabled, the method 1100 proceeds to step 1110 even if the alternator power output is greater than the allowable power output limit. In certain examples, the DTC indicating that the power output of the alternator 420 should be limited may be matured even if the power output is not limited. In an aspect, this can help provide a notification of a change in condition without derating components and/or the converters 122 to below a certain power level that would impact the operation of the vehicle 100.

In some aspect, if the power output of the alternator 420 does not exceed the allowable power output limit, the method 1100 proceeds to step 1110, where the method 1100 determines whether belt slip has been detected. In certain aspects, the method 1100 can determine that belt slip was detected if the belt slip detected parameter was previously enabled, and/or if the DTC indicative of belt slip was previously matured.

In some aspects of the present disclosure, if the belt slip was detected at 1110, the method 1100 proceeds step 1112, where the alternator power output limiting parameter is set to a second value (e.g., denoted as ACTIVE_POWER_LIMIT2) that indicates the electrical system 102 (e.g., the converters) should be set to a power output limiting mode because the belt slip has been detected, or that power limiting is required or desired. In some examples, the step 1112 may optionally include maturing the DTC indicating that the power output of the alternator 420 should be limited.

At step 1110, the method 1100 determines whether the energy management feature enabled parameter and/or the alternator energy management feature enabled parameter are disabled. If one or both of these parameters are disabled, the method 1100 proceeds to step 1114 even if a belt slip has been detected. In one aspect of the present disclosure, the DTC indicating that the power output of the alternator 420 should be limited may still be matured even if the power output is not limited. In an aspect, this can help provide a notification of a change in condition without derating components and/or the converters 122 to below a certain power level that would impact the operation of the vehicle 100.

At step 1114, the method 1100 determines whether the energy management feature enabled parameter and/or the alternator energy management feature enabled parameter are disabled. If one or both of these parameters are disabled, the method 1100 proceeds to step 1122 even if the actual power of the alternator 420 exceeds the total power capability. In some aspects, the DTC indicating that the power output of the alternator 420 should be limited can still be matured even if the power output is not limited. In certain aspects, this can help provide a notification of a change in condition without derating components and/or the converters 122 to below a certain power level that would impact the operation of the vehicle 100.

If belt slip is not detected, the method 1100 proceeds to step 1114, where the method 1100 determines whether the power output of the alternator 420 is greater than the total power capability of the alternator 420 (for example, the nominal or maximum rated power capability of the alternator 420). If the power output of the alternator 420 is greater than the total power capability of the alternator 420, the method 1100 proceeds to step 1116, where the alternator power output limiting parameter is set to a third value (e.g., denoted as ACTIVE_COMPONENT_LIMIT) that indicates the power output of the alternator 420 exceeds its total power capability, and/or that power limiting is required or desired. In an aspect, the step 1116 can optionally include maturing the DTC indicating that the power output of the alternator 420 should be limited.

In some aspects, steps 1108, 1112, and 1116 may include setting the alternator power output limiting parameter to different values (for example, numerical values). In other aspects, at steps 1108, 1112, and 1116, the method 1100 may set the alternator power output limiting parameter to the same numerical value. In yet another aspect, the method 1100 may include setting the alternator power output limiting parameter to the same logical value that indicates alternator power limiting is required or desired. Other implementations may also be used according to various aspects of the present disclosure.

At 1120, after any one of steps 1108, 1112, and 1116, the method 1100 includes reduce voltage setpoint at the DCDC converters. In one example, the power output limit of the alternator 420 may be decreased to a first power output limit after step 1108, a second power output limit after step 1112, and a third power output limit after 1116, by setting various voltage setpoints for the converters 122. In other examples, the first, second, and third power output limits may be different or the same. In one aspect of the present disclosure, the power output of the alternator 420 may be decreased to a value greater than or equal to a minimum power output limit. Here, the minimum power output limit may be the minimum amount of power needed to prevent electrical degradation in the components powered by the alternator 420 (e.g., the electrical system 102 of the vehicle 100). In some aspects, the minimum power output limit may be the amount of electrical power required to power these components in excess of the amount of electrical power provided by the one or more of the battery cells 128. For example, the minimum power output limit can be the sum of one or more of the following: (1) the difference between the electrical power consumed by the electrical load of the first power distribution network 120-1 and the amount of power provided by the first battery cells 128-1, (2) the difference between the electrical power consumed by the electrical load of the second power distribution network 120 and the amount of power provided by the second battery cells 128-2, and/or (3) the difference between the electrical power consumed by the electrical load of the third power distribution network 120 and the amount of power provided by the third battery pack (not shown). As such, the battery cells 128 may provide energy to the power distribution networks 120 in addition to the electrical energy provided by the alternator 420.

If the method 1100 determines that the power output of the alternator 420 does not exceed the total power capability of the alternator 420, the method proceeds to step 1118, where the alternator power output limiting parameter is set to a value (e.g., denoted as LIMITING_INACTIVE) that indicates power limiting is not required or desired. In some aspects, step 1118 may further include de-maturing the DTC that indicates that the alternator power output is being limited.

At 1122, the method 1100 may include increasing the voltage setpoint of the converters 122 so the alternator 420 may operate at a higher power level (e.g., such as the default or nominal power output limit). In certain aspects, the default or nominal power output limit may greater than each one of the first, second, and third power output limits and the minimum power output limit described with respect to step 1120.

In some examples, the updated alternator power output limiting parameter may be stored in a memory unit of the electrical system 102 or the vehicle 100 (e.g., the one or more memories 520) and may be accessed by the processor controlling the operation of the electrical system 102 (e.g., the one or more processors 510). In some examples, this updated parameter can be encoded in a signal that is sent to an external system (for example, an external server, another vehicle, a code reader).

FIG. 12 is a flow chart illustrating a method 1200 of setting a power output limiting reason parameter of a converter (for example, any one or more of the converters 122) according to aspects of the present disclosure. In some examples, and referring to FIGS. 1, 4, 5, and 12, the method 1200 may be performed by the one or more processors 510, the one or more memories 520, the converter ECU 554, the one or more degradation detector 564, and/or the algorithm component 565. In some aspects, the method 1200 (or a portion thereof) illustrated by the flow chart may be performed as part of the method 900 in FIG. 9. Specifically, the method 1200 may be performed as part of or, in lieu of, step 906.

In certain aspects, the method 1200 may be performed jointly and/or separately by the converters 122 of the electrical system 102. Each one of the converters 122 may be set to the same or a different power output limit.

At step 1202, the method 1200 includes receiving data. Example data received at the step 1202 may include a power output of the converter (aDCA_LS_PowerActual_Cval) and/or a power capability of the converter (aDCA_LS_TotalPowerCapability). As used herein, the “power capability” of the converter refers to the maximum nominal output power of the converters 122. In certain aspects of the present disclosure, the power capability of the converters 122 may be determined based on different measured parameters (e.g., temperature, humidity, other environmental conditions, the age of the converter 122, etc.). In an aspect of the present disclosure, the power output of the converters 122 may be above its power capability. However, it may be desirable to keep the power output at or below its power capability to ensure that the converters 122 operates within their design limits. In some aspects, step 1202 may include measuring the power output of the converters 122.

In certain aspects, the data received at step 1202 may further include one or more of the running verified parameter, the energy management feature enabled parameter as discussed above. The data received at step 1202 may include a “DC-DC energy management feature enabled” parameter (e.g., denoted as DCDCEnergyMgmtEnabled). The DC-DC energy management feature enabled parameter may indicate whether the output of the converters 122 should be limited.

At step 1204, the method 1200 includes determining whether the running verified parameter and/or the energy management feature enabled parameter are enabled. If both parameters are enabled, the method 1200 proceeds to step 1206. If at least one of the parameters is disabled, the method 1200 proceed to step 1210. For example, if the DC-DC energy management feature enabled parameter is disabled, the method 1200 proceeds to step 1210 so the converters 122 are prevented from limiting output power to below a certain power level that would impact the operation of the vehicle 100.

At step 1206, the method 1200 includes determining whether the power output of one or more of the converters 122 is greater than the power capability of the corresponding converters 122. Here, the power capability is the reported power capability at that point in time of the converters 122. If the power output of the converters 122 is greater than its power capability, the method 1200 proceeds to step 1208. If the power output does not exceed its power capability, the method 1200 proceeds to step 1210.

At step 1208, the method 1200 includes setting a “voltage converter power output limiting reason” parameter (e.g., denoted as dedcPowerLimitingActiveReason) to a value (such as ACTIVE_COMPONENT_LIMIT) that indicates the power output of one or more of the converters 122 exceeds its power capability, or that power limiting is required or desired. As such, the power output limiting mode of the converters 122 may be enabled or activated. In certain aspects, step 1208 further include maturing a DTC indicating that the power output of one or more of the converters 122 exceeds its power capability.

At step 1210, the method 1200 includes setting the voltage converter power output limiting reason parameter to a value (such as LIMITING_INACTIVE) that indicates power limiting is not required or desired. In some examples, step 1210 may further include de-maturing the DTC indicating that the power output of one or more of the converters 122 exceeds its power capability.

In some examples, the updated voltage converter power output limiting reason parameter can be stored in a memory unit of the electrical system 102 or the vehicle 100 (e.g., the one or more memories 520) and may be accessed by the processor controlling the operation of the electrical system 102 (e.g., the one or more processors 510). In some examples, this updated parameter can be encoded in a signal that is sent to an external system (for example, an external server, another vehicle, a code reader).

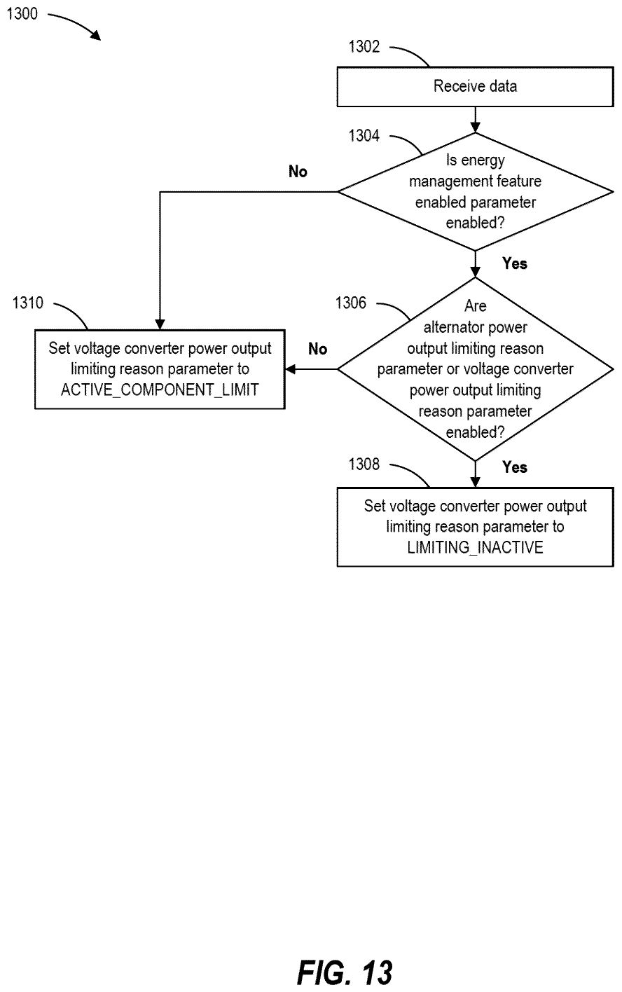

FIG. 13 is a flow chart illustrating a method 1300 of setting (increasing or decreasing) a converter setpoint according to various aspects of the present disclosure. In some examples, and referring to FIGS. 1, 4, 5, and 13, the method 1300 may be performed by the one or more processors 510, the one or more memories 520, the converter ECU 554, the one or more degradation detector 564, and/or the algorithm component 565. In some aspects, the method 1300 may be performed as part of the method 900 in FIG. 9. Specifically, the method 1300 (or a portion thereof) may be performed as part of, or in lieu of, step 908 of FIG. 9.

In certain aspects, the method 1300 may be performed jointly and/or separately by the converters 122 of the electrical system 102. Each one of the converters 122 may be set to the same or a different power output limit.

At 1302, the method 1300 may include receiving data. Example data received include one or more of the energy management feature enabled parameter, the alternator power limiting reason parameter, and the voltage converter power output limiting reason parameter. However, additional data may also include one or more of a current setpoint of the voltage converter, one or more DTCs (for example, DTCs that were matured or de-matured in previous steps or methods), and/or one or more slew rates (discussed with respect to steps 1308 and 1310 below) can also be received.

At 1304, the method 1300 may include determining whether the energy management feature enabled parameter is enabled. If yes, the method 1300 proceeds to step 1306. If no, the method 1300 proceeds to step 1310.

At step 1306, the method 1300 may include determining whether at least one of the alternator power output limiting parameter and/or the voltage converter power output limiting reason parameter is enabled. If yes, the method 1300 proceeds to step 1308. If no, the method 1300 proceeds to step 1310.

At step 1308, the method 1300 may include decreasing the voltage setpoint of the converters 122 from an initial setpoint (e.g., a default or nominal setpoint of the converters 122) to another voltage setpoint (e.g., a minimum voltage setpoint, which may be denoted as DCDC_MinV_Setpoint). The minimum voltage setpoint may be the minimum voltage required to power the components connected to the alternator 420 without resulting in a degradation. For example, the minimum voltage setpoint may be less than 14 volts, less than 13.6 volts, less than 13 volts, less than 12.6 volts, less than 12 volts, or less than 10 volts. The minimum voltage setpoint may be within a range, such as between 5 and 15 volts, 7 and 13 volts, or 11 and 12 volts. Other voltages and/or voltage ranges may also be possible according to various aspects of the present disclosure.

In certain examples, the minimum voltage setpoint may be selected based on the power output limit of the alternator 420. For example, the minimum voltage setpoint may be the voltage at which the total amount of power output by the converters 122 equals the amount of power output by the alternator 420. In another example, the minimum voltage setpoint may be the voltage at which the total amount of power output by the converters 122 equals the minimum power output limit of the alternator 420. In yet another example, the minimum voltage setpoint can be the voltage at which the total amount of power output by the converters 122 equals the difference between the electrical load connected to the converters 122 and the amount of power output by a respective battery cells 128 connected to the output of the converters 122. Other ways of defining the minimum voltage setpoint may also be used.

In some aspects, step 1308 may include decreasing the setpoint of the voltage converter at a first slew rate (e.g., denoted as DCDC_V_DecreaseSlewRate_mVpSec).

In some aspects, step 1308 may include setting an energy management power limiting active parameter (energyMgmtPowerLimitingActive) to TRUE.

In some aspects, step 1308 may include maturing a DTC indicating that the setpoint has been lowered and that power from the converters 122 is being limited.

In some aspects, step 1308 may include sending a command to an ECU of the vehicle 100 (e.g., the converter ECU 554) to decrease the setpoint of the converters 122.

At step 1310, the method 1300 may include setting a voltage converter power output limiting reason parameter to a value (such as ACTIVE_COMPONENT_LIMIT) that indicates the power output of one or more of the converters 122 exceeds its power capability, or that power limiting is required or desired. As such, the power output limiting mode of the converters 122 may be enabled or activated. In certain aspects, step 1310 further include maturing a DTC indicating that the power output of one or more of the converters 122 exceeds its power capability.

In some aspects, step 1310 may include sending a command to an ECU of the vehicle 100 (e.g., the converter ECU 556) to increase the setpoint of the converters 122.

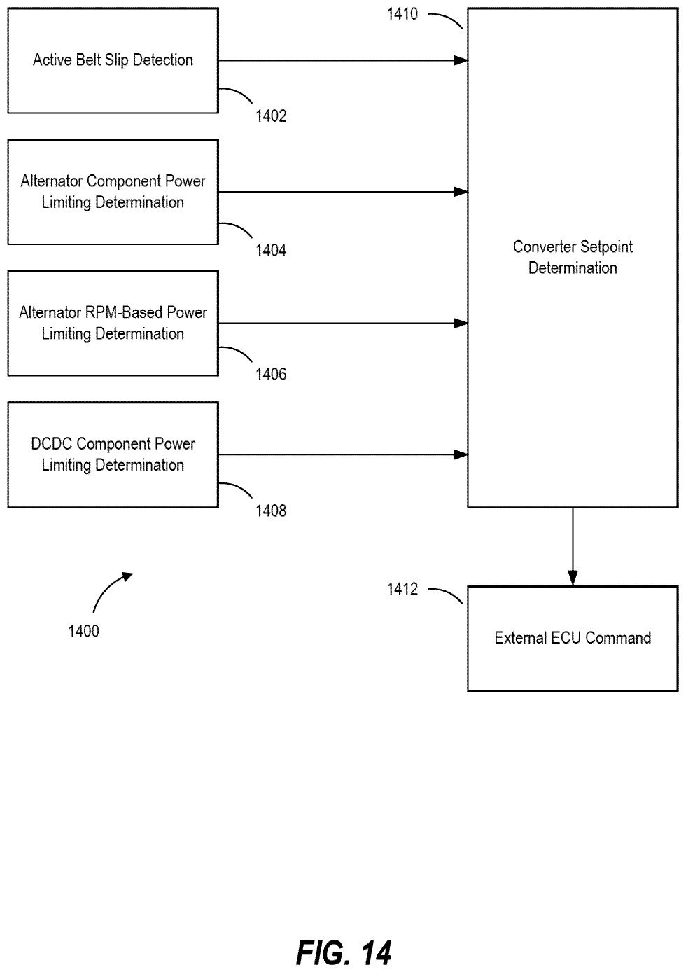

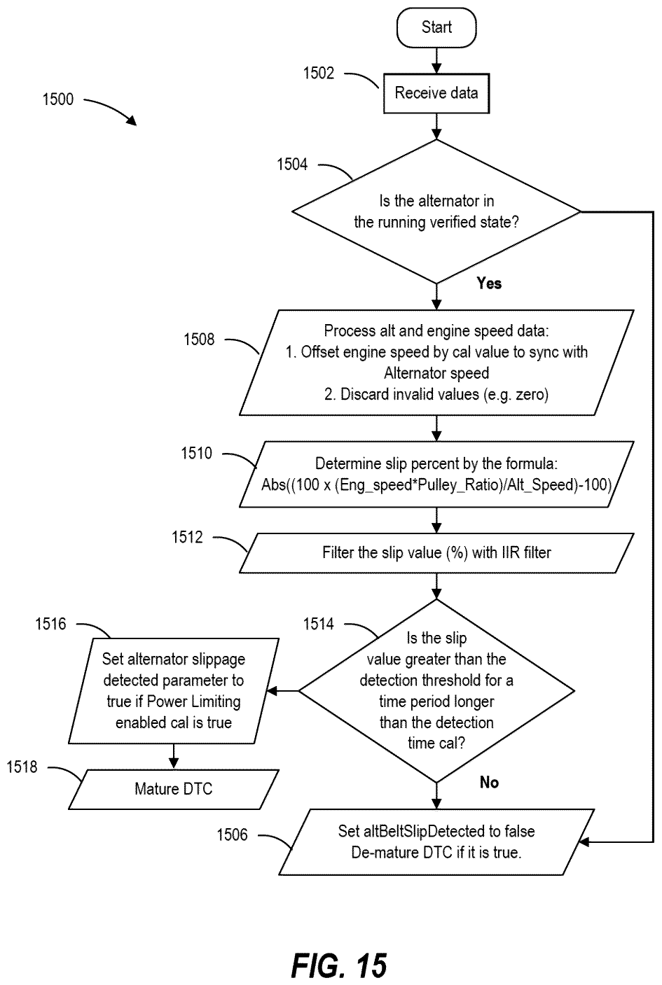

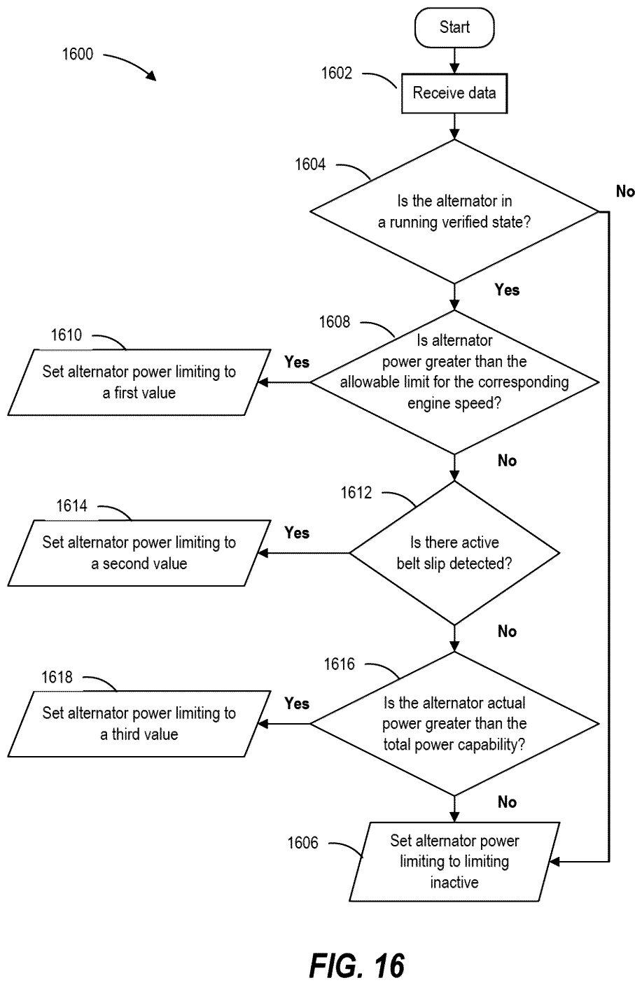

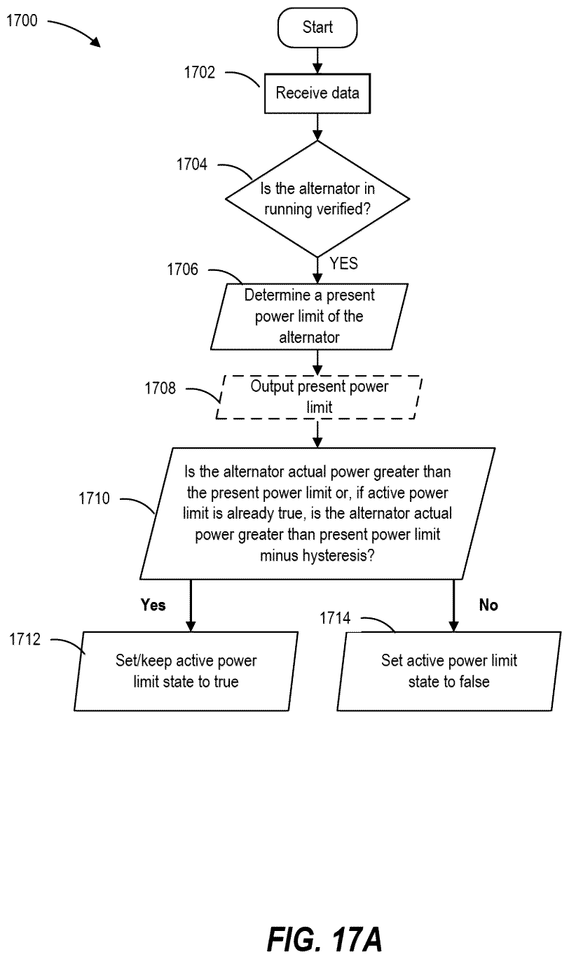

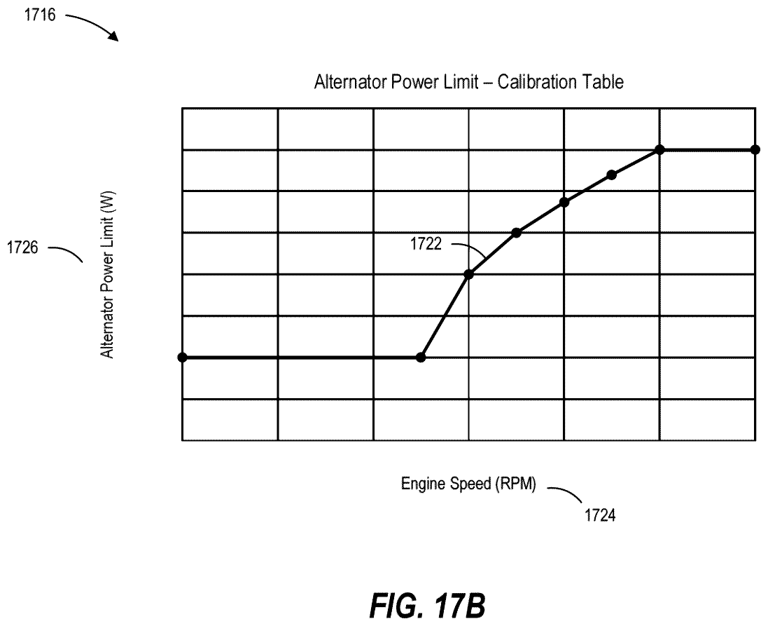

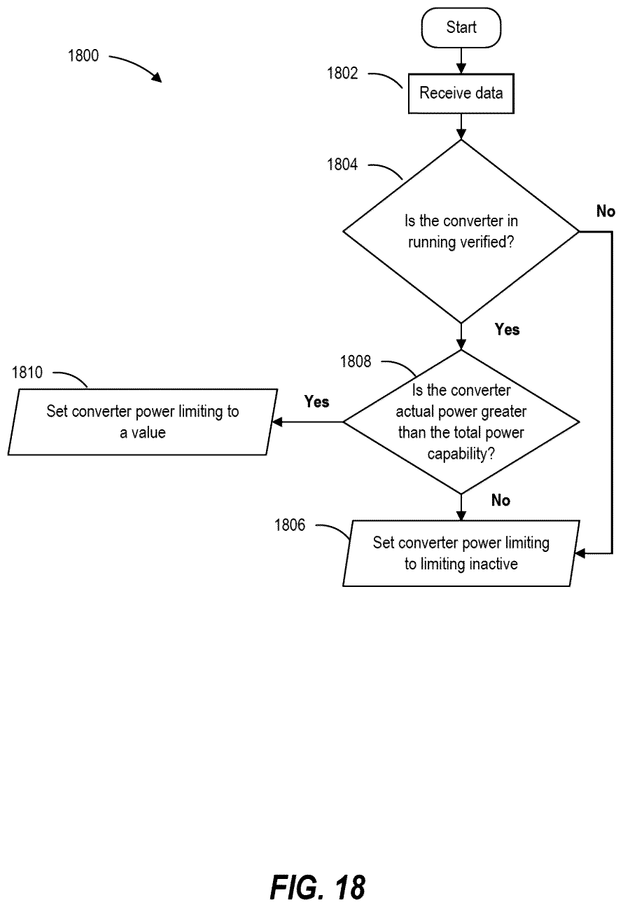

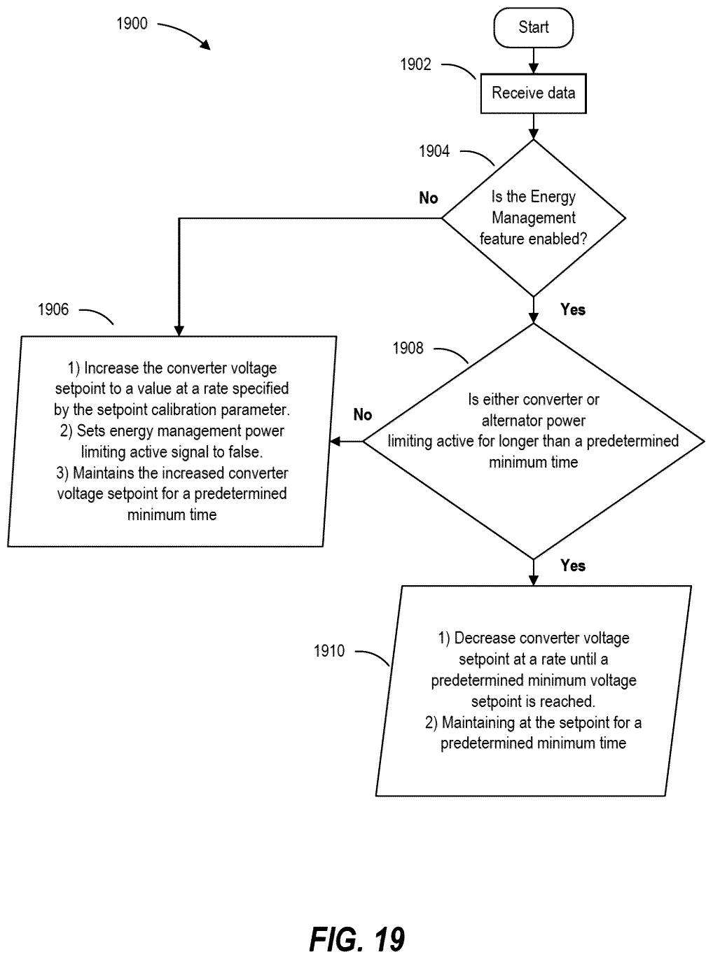

FIG. 14 is a block diagram of an energy management system 1400 for energy management according to aspects of the present disclosure. The energy management system 1400 may be implemented by various hardware and/or software components of the electrical system 102 (FIG. 1), the alternator 420 (FIG. 4), and/or the controller 190 (FIG. 5). For example, in one aspect of the present disclosure, the electrical system 102, the alternator 420, the converters 122, the power distribution devices 124, the controller 190, the one or more processors 510, the one or more memories 520, the power generator ECU 550, the power distribution ECU 552, the degradation detector 564, the algorithm component 565, and/or the converter ECU 554 may be configured to, and/or provide means for, implementing various features and/or methods executed by the energy management system 1400, including methods 1500 (FIG. 15), 1600 (FIG. 16), 1700 (FIGS. 17A and B), 1800 (FIG. 18), 1900 (FIG. 19) as described below.

Referring to FIGS. 1, 5, and 14, the energy management system 1400 includes a converter setpoint determination module 1410 configured to receive power limiting parameters from a set of modules that may determine the power limiting parameters according to the methods describe with respect to FIGS. 15-19. The converter setpoint determination module 1410 outputs a converter derating command to an external ECU command module 1412 based on the received power limiting parameters. According to aspects of the present disclosure, the energy management system 1400 may be configured to transmit signals to, and/or receive signals from, one or more of the alternator 420, the converters 122, and/or other components of the electrical system 102.

In some aspects, the converter setpoint determination module 1410 may be implemented by the electrical system 102, the converters 122, the power distribution devices 124, the controller 190, the one or more processors 510, the one or more memories 520, the power distribution ECU 552, and/or the converter ECU 554. The external ECU command module 1412 may be implemented by the electrical system 102, the power distribution devices 124, the controller 190, the one or more processors 510, the one or more memories 520, and/or the power distribution ECU 552.

In some aspects, the energy management system 1400 includes an active belt slip detection module 1402 configured to detect active belt slippage and/or set an alternator slippage parameter (e.g., denoted as altBeltSlipDetected) according to the method 1500 of FIG. 15. The active belt slip detection module 1402 may be implemented by one or more of the electrical system 102, the alternator 420, the power distribution devices 124, the controller 190, the one or more processors 510, the one or more memories 520, the power generator ECU 550, the power distribution ECU 552, the degradation detector 564, and/or the algorithm component 565.

In some aspects, the energy management system 1400 includes an alternator component power limiting determination module 1404 configured to determine alternator power limiting parameters (e.g., denoted as altPwrLimActvRsn) according to the method 1600 of FIG. 16. The alternator component power limiting determination module 1404 may be implemented by one or more of the electrical system 102, the alternator 420, the power distribution devices 124, the controller 190, the one or more processors 510, the one or more memories 520, the power generator ECU 550, the power distribution ECU 552, the degradation detector 564, and/or the algorithm component 565.

In some aspects, the energy management system 1400 includes an alternator RPM-based power limiting determination module 1406 configured to determine RPM based alternator power limiting parameters according to the method 1700 of FIGS. 17A-B. The alternator RPM-based power limiting determination module 1406 may be implemented by one or more of the electrical system 102, the alternator 420, the power distribution devices 124, the controller 190, the one or more processors 510, the one or more memories 520, the power generator ECU 550, the power distribution ECU 552, the degradation detector 564, and/or the algorithm component 565.

In some aspects, the energy management system 1400 includes a converter component power limiting determination module 1408 configured to determine converter component power limiting parameters according to the methods 1800 of FIGS. 18 and 1900 FIG. 19. The converter component power limiting determination module 1408 may be implemented by one or more of the electrical system 102, the converters 122, the power distribution devices 124, the controller 190, the one or more processors 510, the one or more memories 520, the power distribution ECU 552, and/or the converter ECU 554.

FIG. 15 is a flow chart illustrating a method 1500 for active belt slip detection, such as detecting belt slip of the belt 421 of the alternator 420 of the vehicle 100 according to aspects of the present disclosure. The method 1500 detects active steady-state belt slip and signals to the electrical system 102 a request to limit power and/or to set a diagnostic test code (DTC). In one aspect of the present disclosure, the electrical system 102, the alternator 420, the converters 122, the power distribution devices 124, the controller 190, the one or more processors 510, the one or more memories 520, the power generator ECU 550, the power distribution ECU 552, the degradation detector 564, the algorithm component 565, and/or the converter ECU 554 may be configured to, and/or provide means for, implementing the method 1500.

At 1502, the method 1500 may include receiving input data including one or more of an alternator mode (e.g., denoted as altModeCmd), an alternator RPM calibration value, and/or an engine speed calibration value.

At 1504, the method 1500 may include determining whether the alternator 420 is in a running verified condition based on the alternator mode status. In an optional aspect, the method 1500 may determine that the alternator 420 is the running verified condition state and that an active slip determination feature is enabled. If the alternator 420 is not in a running verified state or an active slip determination feature is not enabled at 1504, then at 1506 an alternator belt slip detected parameter is set to false and/or the DTC is de-matured. If the alternator 420 is in a running verified state, or if the alternator 420 is in a running verified state and an active slip determination feature is enabled at 1504, then at 1508, the alternator speed data and engine speed data are processed by offsetting engine speed by a calibration value to synchronize the engine speed with the alternator speed and discarding invalid values (e.g. zero).

At 1510, the method 1500 computes a slip percentage. Slip percentage may be computed according to the formula: Abs ((100×(Eng_speed×Pulley_Ratio)/Alt_Speed)−100), where Eng_speed is an engine speed in RPMs, Alt_Speed is an alternator speed in RPMs, and Pulley_Ratio represents a ratio of the engine pulley size to the alternator pulley size.

At 1512, the method 1500 filters the computed slip percentage using an Infinite Impulses Response (IIR) filter to generate a filtered slip value.

At 1514, the method 1500 determines whether the filtered slip value is greater than a detection threshold for a time period longer than a detection time calibration parameter. If the filter slip value is not greater than the detection threshold or if the time period is not longer than the time calibration parameter at 1514, then at 1506 the alternator belt slip detected parameter is set to false and/or the DTC is de-matured. If the filter slip value is greater than the detection threshold for the time period longer than the time calibration parameter and a power limiting enable parameter is set to true at 1514, then at step 1516 the method 1500 sets the alternator belt slip detected parameter to true and at step 1518 matures the DTC.

FIG. 16 is a flow chart illustrating a method 1600 for alternator power limiting determination according to aspects of the present disclosure. In one aspect of the present disclosure, the electrical system 102, the alternator 420, the power distribution devices 124, the controller 190, the one or more processors 510, the one or more memories 520, the power generator ECU 550, the power distribution ECU 552, the degradation detector 564, and/or the algorithm component 565 may be configured to, and/or provide means for, implementing the method 1600.

At 1602, the method 1600 may include receiving input data such as an alternator mode, an alternator RPM calibration value (which may be the power limit of the alternator 420 at a given engine speed as described below), an alternator power present value, an alternator total power capability value, and/or an alternator belt slip detected state value.

At 1604, the method 1600 may include determining whether the alternator 420 is in a running verified state based on the value of the alternator mode status. If the alternator 420 is not in the running verified state, then at 1606 the method 1600 sets an alternator power limiting parameter to a state that indicates power limiting is not required or desired. If the alternator 420 is in a running verified state, then at step 1608 the method 1600 determines whether alternator power is greater than an allowed limit for a corresponding engine speed. Here the alternator power may be the alternator power present value transmitted by the alternator 420.

In an optional implementation for 1604, the method 1600 may also determine whether an energy management feature is enabled. If the alternator 420 is not in the running verified state or the energy management feature is not enabled, then at 1606 the method 1600 sets the alternator power limiting parameter to a state that indicates power limiting is not required or desired. If the alternator 420 is in the running verified state and the energy management feature is enabled, then the method 1600 proceeds to step 1608 as described above.

At 1608, if the alternator power is greater than an allowed limit for a corresponding engine speed, then at 1610 the method 1600 sets the alternator power limiting parameter to a first value that indicates the alternator 420 should be set to a power output limiting mode because the power output of the alternator 420 exceeds the allowable power output limit, and/or that power limiting is required or desired. Here, the allowable power output limit of the alternator 420 may be determined as discussed in FIGS. 17A and 17B and the correspond disclosures. Specifically, the allowable power output limit of the alternator 420 may be determined based on the RPM of the engine. If the alternator power is not greater than an allowed limit for a corresponding engine speed at 1608, then at 1612 the method 1600 determines whether active belt slip is detected.

At 1622, if an active belt slip is detected based on the alternator belt slip detected state value, then at 1614 the method 1600 sets the alternator power limiting parameter to a second value that indicates the alternator 420 belt slip has occurred. If active belt slip is not detected, then at 1616 the method 1600 determines whether the alternator actual power is greater than a total power capability as indicated in the alternator total power capability value.

When the alternator actual power is greater than the total power capability at 1616, then at 1618 the method 1600 sets the alternator power limiting parameter to a third value that indicates the power output of the alternator 420 exceeds its total power capability, and/or that power limiting is required or desired. If the alternator actual power is not greater than the total power capability at 1616, then at 1606 the method sets an alternator power limiting parameter to a value that indicates power limiting is not required or desired (e.g., limiting inactive).

In some aspects of the present disclosure, two or more of the first value, the second value, and/or the third value may be the same or different. Further, while the method 1600 shows a path that progresses from 1608 to 1612 to 1616, aspects of the present disclosure include changing the orders of steps 1608, 1612, and 1616. For example, in one aspect, a method of alternator power limiting determination may include checking whether there is an active belt slip detected (shown in 1612) before determining whether the alternator power is greater than the allowable limit (shown in 1608). In another example, a method of alternator power limiting determination may include only steps 1612 and 1616 without step 1608. Other combinations and/or sequences may also be possible according to various aspects of the present disclosure.

FIG. 17A is a flow chart illustrating a method 1700 for determining the alternator RPM based power limiting according to aspects of the present disclosure. In one aspect of the present disclosure, the electrical system 102, the alternator 420, the power distribution devices 124, the controller 190, the one or more processors 510, the one or more memories 520, the power generator ECU 550, the power distribution ECU 552, the degradation detector 564, and/or the algorithm component 565 may be configured to, and/or provide means for, implementing the method 1700.

At 1702, the method 1700 may include receiving input data such as an alternator mode, an engine speed present value signal an alternator RPM calibration value, an alternator speed present value, and/or an alternator actual power calibration value (e.g., denoted as aAlt_PowerActual_Cval).

At 1704, the method 1700 may include determining whether the alternator 420 is in a running verified state based on the value of the alternator mode. In an optional implementation for 1704, the method 1700 may also determine whether an energy management feature is enabled. If the alternator 420 is in the running verified state and the energy management feature is enabled, then the method 1700 proceeds to step 1706.

At 1706, if the alternator 420 is in the running verified state (or if the alternator 420 is in the running verified state and the energy management feature is enabled), the method 1700 determines a present power limit (e.g., denoted as altPowerRPMLim_W) of the alternator 420 based on the present engine speed (e.g., rotational speed and/or RPM as indicated the engine speed present value signal) the present alternator speed (e.g., rotational speed and/or RPM as indicated in the alternator speed present value signal transmitted by the alternator 420) of the alternator 420. In one aspects of the present disclosure, the method 1700 looks up the present alternator speed and determines a corresponding power limit in an alternator speed power limiting table 1716 shown in FIG. 17B. Here, the alternator speed power limiting table 1716 shows a relationship between the engine speed 1724 and the alternator power limit 1726. Specifically, the alternator speed power limiting table 1716 shows the calibration values 1722 at certain engine speeds. Other schemes for determining the power limit of the alternator 420 may also be used according to aspects of the present disclosure.

At 1708, the method 1700 optionally outputs a present power limit.

At 1710, the method 1700 determines whether the alternator actual power calibration value is greater than the present power limit. If the alternator actual power is greater than the present power limit, then at 1712 the method 1700 sets the active power limit state (e.g., denoted as ACTIVE_PWR_LIMIT1) to true.

If active power limit state is already true at step 1710, then the method 1700 determines whether the alternator actual power is greater than the present power limit minus hysteresis (in Watts) (e.g., denoted as K_IPDMA_AltPowerLimit-Hysteresis_W). If the alternator actual power is greater than the difference between the present power limit and the hysteresis at step 1710, then at 1712 the method 1700 keeps the active power limit state set to true.

At 1714, if the alternator actual power is not greater than the difference between the present power limit and the hysteresis, then the method 1700 sets the active power limit state to false.

FIG. 18 is a flow chart illustrating a method 1800 for converter power limit determination according to an aspect of the present disclosure. In one aspect of the present disclosure, the electrical system 102, the converters 122, the power distribution devices 124, the controller 190, the one or more processors 510, the one or more memories 520, the power distribution ECU 552, and/or the converter ECU 554 may be configured to, and/or provide means for, implementing the method 1800.

At 1802, the method 1800 may include receiving input data such as a converter mode (e.g., denoted as dcaModeCmd), a converter total power capability (e.g., denoted as aDCA_LS_TotalPowerCapability) and a converter actual power calibration value (e.g., denoted as aDCA_LS_PowerActual_Cval).

At 1804, the method 1800 may include determining whether one or more of the converters 122 is in a running verified state based on the value of the converter mode that indicates the status of the converters 122. Here, the converter mode signal may be transmitted by one or more of the converters 122 to indicate the respective status of the converters 122. In an optional implementation for 1804, the method 1800 may also determine whether an energy management feature is enabled. If the one or more of the converters 122 is not in the running verified state, or if the one or more of the converters 122 is not in the running verified state or the energy management feature is not enabled, the method 1800 proceeds to 1806. If the one or more of the converters 122 is in the running verified state, or if the one or more of the converters 122 is in the running verified state and the energy management feature is enabled, the method 1800 proceeds to 1808.

At 1806, the method 1800 sets a converter power limiting state to a state that indicates power limiting is not required or desired for the one or more converters 122.

At 1808, the method 1800 determines whether the converter actual power calibration value is greater than the converter total power capability. If yes, the method 1800 proceeds to 1810 to set the converter power limiting to a value. Here, the converter power limiting value may be determined by the method 1900 described in FIG. 19.

If the method 1800 determines the converter actual power calibration value is not greater than the converter total power capability, the method 1800 proceeds to 1806 to set the converter power limiting state to a state that indicates power limiting is not required or desired for the one or more converters 122.

FIG. 19 is a flow chart illustrating a method 1900 for converter setpoint determination according to an aspect of the present disclosure. In one aspect of the present disclosure, the electrical system 102, the converters 122, the power distribution devices 124, the controller 190, the one or more processors 510, the one or more memories 520, the power distribution ECU 552, and/or the converter ECU 554 may be configured to, and/or provide means for, implementing the method 1900.

At 1902, the method 1900 may include receiving input data such as an energy management feature enabled parameter, an alternator power limiting activated state, and/or a converter power limiting activated state (e.g., denoted as dcdcPwrLimActvRsn).

At 1904, the method 1900 may include determining whether an energy management feature is enabled based on the energy management feature enabled parameter.

At 1906, if the energy management feature is not enabled, the method 1900 performs one or more of the following: increases a converter voltage setpoint to a value (e.g., a nominal value) at a rate specified by a setpoint calibration parameter (e.g., denoted as K_DCDC_ModeBuck_LSV_SetpointV), sets an energy management power limiting active state to false, and/or maintains the increased converter voltage setpoint for a predetermined minimum time (e.g., denoted as K_EM_VMaintainTime_msec).

At 1908, if the energy management feature is enabled at 1904, the method 1900 determines whether either the converter power limiting is active (based on the value of the converter power limiting activated state) or the alternator power limiting is active (based on the alternator power limiting activated state) for longer than the time specified by the predetermined minimum time. If neither the converter power limiting nor the alternator power limiting is active for longer than the predetermined minimum time, the method 1900 proceeds to 1906 as described above. If either the converter power limiting or the alternator power limiting is active for longer than the predetermined minimum time, the method proceeds to 1910.

At 1910, the method 1900 performs one or more of the following: decreases the converter voltage setpoint at a rate specified by a predetermined slew rate parameter (e.g., denoted as K_EM_DcdcVSlewRate_mVpSec) until a predetermined minimum voltage calibration setpoint (e.g., denoted as K_EM_DcdcMiinVSetpoint_V) is reached. Once the minimum voltage calibration setpoint is reached, it is maintained for the predetermined minimum time.

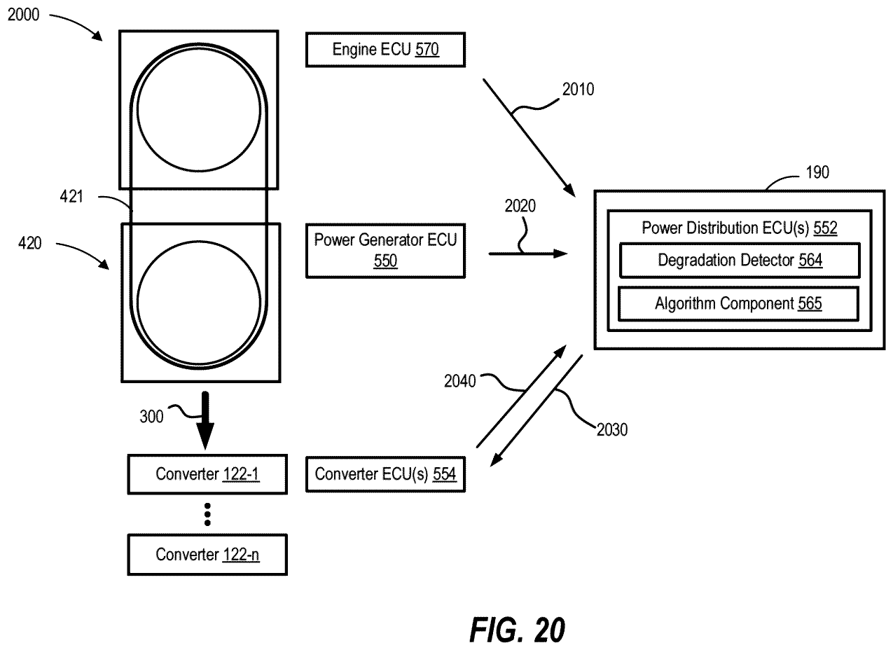

FIG. 20 is a block diagram illustrating an example of an operational scheme for energy management according to various aspects of the present disclosure. Referring to FIGS. 1, 4, 5, and 20, in some aspects of the present disclosure, an engine 2000 drives the alternator 420 via the belt 421 to generate the one or more supplied currents 300 for the components in the electrical system 102 as described above. Specifically, the alternator 420 provides the one or more supplied currents 300 to the components in the electrical system 102 via the one or more converters 122. Here, the engine 2000 may be a gasoline engine, a diesel engine, or other suitable engines configured to mechanically drive the alternator 420 as know to ones skilled in the art.

However, in some instances, the one or more supplied currents 300 may be (temporarily) unable to meet the energy demand of the electrical system 102, or generating the one or more currents 300 leads to undesirable effects to vehicle 100. For example, the energy (measured in voltage, current, joules, and/or power) generated by the alternator 420 may be insufficient to meet the energy demand due to the speed of the engine 2000 being unable to sufficiently drive the alternator 420. In another example, as the alternator 420 is be driven by the engine 2000, the torque applied to the alternator 420 and/or the engine 2000 may cause the belt 421 to “slip.” Such slip may cause physical damage to the belt 421, undervoltage by the alternator 420, and/or other undesirable effects. In yet another example, even though the alternator 420 is supplying sufficient energy (e.g., the one or more output currents 300) to the electrical system 102, the energy generated exceeds a power capability of the alternator 420. As such, this may cause damage to the alternator 420 or other components in the electrical system 102. Aspects of the present disclosure includes schemes to address the undesirable effects as described below.

In a first aspect of the present disclosure, one or more of the controller 190, the power distribution device 124, and/or the power distribution ECU 552 receives a signal 2010 from the engine ECU 570. The signal 2010 indicates the engine speed of the engine 2000. Based on the engine speed, the algorithm component 565 determines the alternator power limit of the alternator 420 using various methods (such as ones described with respect to FIGS. 17A-B). Further, one or more of the controller 190, the power distribution device 124, and/or the power distribution ECU 552 receives a signal 2020 from power generator ECU 550. The signal 2020 indicates the present alternator power provided by alternator 420. The controller 190, the power distribution device 124, the power distribution ECU 552, and/or the algorithm component 565 compare the current alternator power to the alternator power limit at the present engine speed. If the present alternator power exceeds the alternator power limit, one or more of the controller 190, the power distribution device 124, and/or the power distribution ECU 552 sends a signal 2030 to the converter ECU 554 to lower the voltage setpoint of the one or more converters 122. As such, the one or more converters 122 will draw less current from the alternator 420, which lowers the alternator power. In some cases, lowering the voltage setpoint of the one or more converters 122 may lower the alternator power to below the alternator power limit at the present engine speed.

In a second aspect of the present disclosure, one or more of the controller 190, the power distribution device 124, and/or the power distribution ECU 552 receives the signal 2010 from the engine ECU 570. The signal 2010 indicates the engine speed of the engine 2000. Further, one or more of the controller 190, the power distribution device 124, and/or the power distribution ECU 552 receives the signal 2020 from power generator ECU 550. The signal 2020 indicates the present alternator speed of the alternator 420. The controller 190, the power distribution device 124, and/or the power distribution ECU 552 obtain a pulley ratio associated with the engine 2000, the alternator 420, and/or the belt 421 (e.g., from the one or more memories 520). Based on the engine speed, the alternator speed, and/or the pulley ratio, the algorithm component 565 determines a slip value using various methods (such as ones described with respect to FIG. 15). If the slip value is larger than a threshold value, or if the slip value is larger than a threshold value for a predetermined duration, one or more of the controller 190, the power distribution device 124, and/or the power distribution ECU 552 sends the signal 2030 to the converter ECU 554 to lower the voltage setpoint of the one or more converters 122. By reducing the voltage setpoint of the one or more converters 122, the one or more converters 122 will draw less current from the alternator 420. As such, the power provided by the alternator 420 will reduce, which diminishes the chance and/or severity of the slippage of the belt 421.

In a third aspect of the present disclosure, one or more of the controller 190, the power distribution device 124, and/or the power distribution ECU 552 receive information indicating the total power consumption by the electrical system 102. For example, one or more of the controller 190, the power distribution device 124, and/or the power distribution ECU 552 receive the signal 2020 from the power generator ECU 550 and/or a signal 2040 from the converter ECU 554. The signals 2020, 2040 may indicate the total power consumption by the electrical system 102. The algorithm component 565 obtains the power capability of the alternator 420 (e.g., from the one or more memories 520). If the total power consumption by the electrical system 102 exceeds the power capability of the alternator 420, one or more of the controller 190, the power distribution device 124, and/or the power distribution ECU 552 sends the signal 2030 to the converter ECU 554 to lower the voltage setpoint of the one or more converters 122. By reducing the voltage setpoint of the one or more converters 122, the one or more converters 122 will draw less current from the alternator 420.

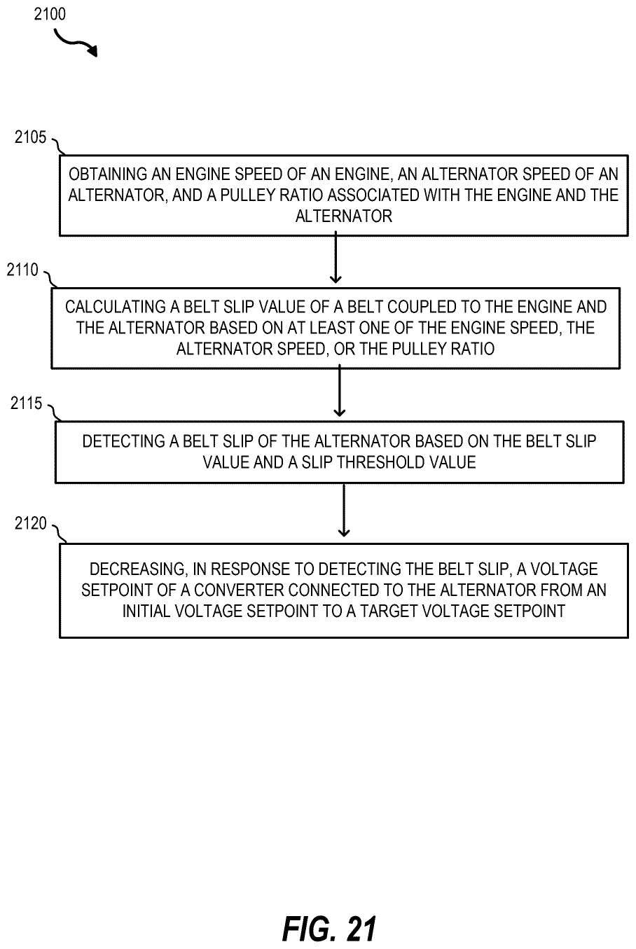

FIG. 21 is a flow chart illustrating a method 2100 of implementing energy management according to aspects of the aspects of the present disclosure. Referring to FIGS. 1, 4, 5, 20, and 21, the engine 2000, the alternator 420, the belt 421, the controller 190, the one or more converters 122, the power distribution device 124, the power distribution ECU 552, the power generator ECU 550, the converter ECU 554, the engine ECU 570, the degradation detector 564, and/or the algorithm component 565 may be configured to, and/or provide means for, performing the method 2100 of implementing energy management.

At 2105, the method 2100 may include obtaining an engine speed of an engine, an alternator speed of an alternator, and a pulley ratio associated with the engine and the alternator. For example, the engine 2000, the alternator 420, the belt 421, the controller 190, the power distribution device 124, the power distribution ECU 552, the power generator ECU 550, and/or the engine ECU 570, may be configured to, and/or provide means for, obtaining an engine speed of an engine, an alternator speed of an alternator, and a pulley ratio associated with the engine and the alternator.

At 2110, the method 2100 may include calculating a belt slip value of a belt coupled to the engine and the alternator based on at least one of the engine speed, the alternator speed, or the pulley ratio. For example, the controller 190, the power distribution device 124, the power distribution ECU 552, the degradation detector 564, and/or the algorithm component 565 may be configured to, and/or provide means for, calculating a belt slip value of a belt coupled to the engine and the alternator based on at least one of the engine speed, the alternator speed, or the pulley ratio.

At 2115, the method 2100 may include detecting a belt slip of the alternator based on the belt slip value and a slip threshold value. For example, the controller 190, the power distribution device 124, the power distribution ECU 552, the degradation detector 564, and/or the algorithm component 565 may be configured to, and/or provide means for, detecting a belt slip of the alternator based on the belt slip value and a slip threshold value.

At 2120, the method 2100 may include decreasing, in response to detecting the belt slip, a voltage setpoint of a converter connected to the alternator from an initial voltage setpoint to a target voltage setpoint. For example, the controller 190, the one or more converters 122, the power distribution device 124, the power distribution ECU 552, and/or the converter ECU 554 may be configured to, and/or provide means for, decreasing, in response to detecting the belt slip, a voltage setpoint of a converter connected to the alternator from an initial voltage setpoint to a target voltage setpoint.

Aspects of the present disclosure include a method of energy management including obtaining an engine speed of an engine, an alternator speed of an alternator, and a pulley ratio associated with the engine and the alternator, calculating a belt slip value of a belt coupled to the engine and the alternator based on at least one of the engine speed, the alternator speed, or the pulley ratio, detecting a belt slip of the alternator based on the belt slip value and a slip threshold value, and decreasing, in response to detecting the belt slip, a voltage setpoint of a converter connected to the alternator from an initial voltage setpoint to a target voltage setpoint.

Aspects of the present disclosure include the method above, further including obtaining one or more calibration values, synchronizing the engine speed to the alternator speed using the one or more calibration values to generate at least one of a calibrated engine speed and a calibrated alternator speed, wherein calculating the belt slip value comprises calculating the belt slip value based on the calibrated engine speed, the calibrated alternator speed, and the pulley ratio.

Aspects of the present disclosure include any of the methods above, where calculating the belt slip value comprises calculating based on an equation

$${ρ}_{slip} = \vert \frac{100 ( {ω}_{engine} {φ}_{p ulley} )}{{ω}_{alternator}} - 100 \vert ,$$

wherein ρₛₗᵢₚ is the belt slip value, ω_{engine} is the engine speed, ωₐₗₜₑᵣₙₐₜₒᵣ is the alternator speed, and φ_{pulley} is the pulley ratio.

Aspects of the present disclosure include any of the methods above, wherein detecting the belt slip comprises comparing the belt slip value to the slip threshold value and determining that the belt slip value is greater than the slip threshold value.

Aspects of the present disclosure include any of the methods above, wherein detecting the belt slip further comprises determining that the belt slip value is greater than the slip threshold value for a period longer than a threshold period.

Aspects of the present disclosure include any of the methods above, further comprising, after calculating the belt slip value, filtering a belt slip value to generate a filtered belt slip value, wherein detecting the belt slip comprises comparing the filtered belt slip value to the slip threshold value and determining that the filtered belt slip value is greater than the slip threshold value for a period longer than a threshold period.

Aspects of the present disclosure include any of the methods above, wherein decreasing the voltage setpoint of a converter comprises decreasing the voltage setpoint at a rate until reaching the target voltage setpoint and maintaining the voltage setpoint at the target voltage setpoint for a predetermined time.

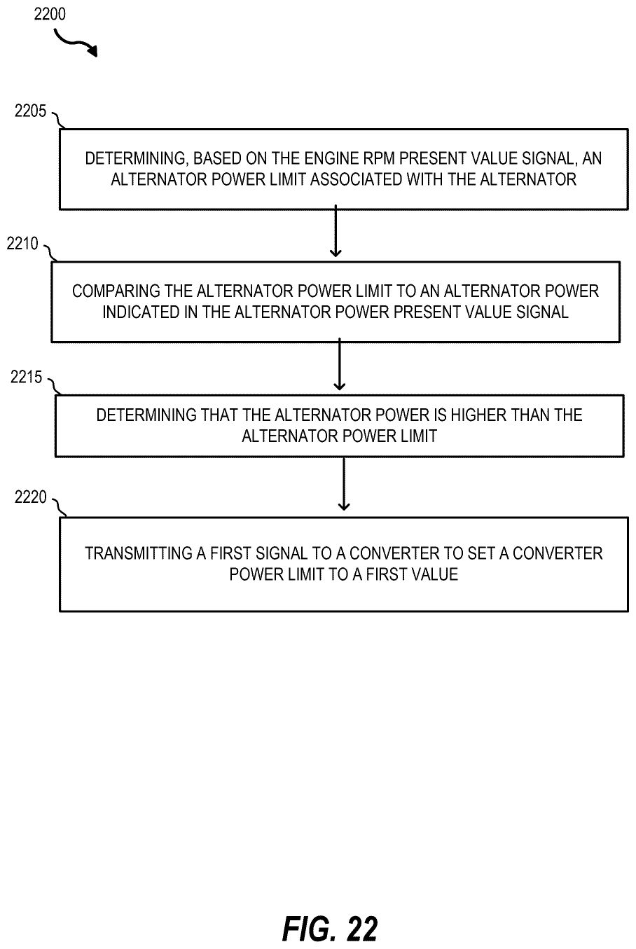

FIG. 22 is a flow chart illustrating a method 2200 of implementing energy management according to aspects of the aspects of the present disclosure. Referring to FIGS. 1, 4, 5, 20, and 22, the engine 2000, the alternator 420, the belt 421, the controller 190, the one or more converters 122, the power distribution device 124, the power distribution ECU 552, the power generator ECU 550, the converter ECU 554, the engine ECU 570, the degradation detector 564, and/or the algorithm component 565 may be configured to, and/or provide means for, performing the method 2200 of implementing energy management.

At 2205, the method 2200 may include determining, based on the engine RPM present value signal, an alternator power limit associated with the alternator. For example, the engine 2000, the controller 190, the power distribution device 124, the power distribution ECU 552, the power generator ECU 550, and/or the engine ECU 570 may be configured to, and/or provide means for, determining, based on the engine RPM present value signal, an alternator power limit associated with the alternator.

At 2210, the method 2200 may include calculating a belt slip value of a belt coupled to the engine and the alternator based on at least one of the engine speed, the alternator speed, or the pulley ratio. For example, the controller 190, the power distribution device 124, the power distribution ECU 552, the degradation detector 564, and/or the algorithm component 565 may be configured to, and/or provide means for, calculating a belt slip value of a belt coupled to the engine and the alternator based on at least one of the engine speed, the alternator speed, or the pulley ratio.

At 2215, the method 2200 may include detecting a belt slip of the alternator based on the belt slip value and a slip threshold value. For example, the controller 190, the power distribution device 124, the power distribution ECU 552, the degradation detector 564, and/or the algorithm component 565 may be configured to, and/or provide means for, detecting a belt slip of the alternator based on the belt slip value and a slip threshold value.

At 2220, the method 2200 may include decreasing, in response to detecting the belt slip, a voltage setpoint of a converter connected to the alternator from an initial voltage setpoint to a target voltage setpoint. For example, the controller 190, the one or more converters 122, the power distribution device 124, the power distribution ECU 552, and/or the converter ECU 554 may be configured to, and/or provide means for, decreasing, in response to detecting the belt slip, a voltage setpoint of a converter connected to the alternator from an initial voltage setpoint to a target voltage setpoint.

Aspects of the present disclosure include a method of energy management including determining, based on the engine RPM present value signal, an alternator power limit associated with the alternator, comparing the alternator power limit to an alternator power indicated in the alternator power present value signal, determining that the alternator power is higher than the alternator power limit, and transmitting a first signal to a converter to set a converter power limit to a first value.

Aspects of the present disclosure include the method above, wherein determining the alternator power limit comprises identifying an engine RPM based on the engine RPM present value signal and determining the alternator power limit based on the engine RPM.

Aspects of the present disclosure include any of the methods above, wherein determining the alternator power limit further comprises identifying the alternator power limit associated with the engine RPM via an equation, a chart, or a lookup table.

Aspects of the present disclosure include any of the methods above, wherein the alternator power capability limit is lower than the alternator power limit associated with the engine RPM.

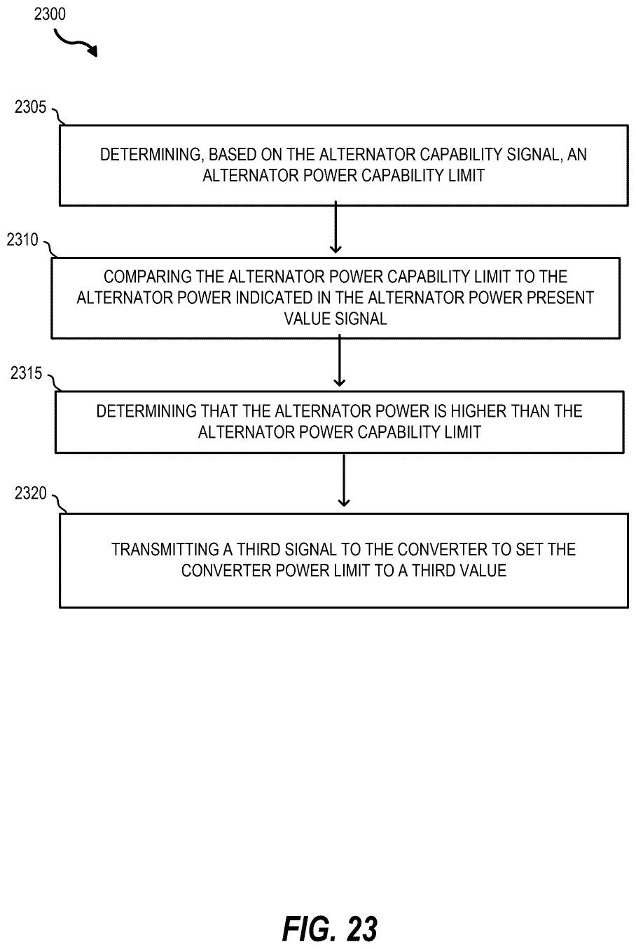

FIG. 23 is a flow chart illustrating a third method 2300 of implementing energy management according to aspects of the aspects of the present disclosure. Referring to FIGS. 1, 4, 5, 20, and 23, the engine 2000, the alternator 420, the belt 421, the controller 190, the one or more converters 122, the power distribution device 124, the power distribution ECU 552, the power generator ECU 550, the converter ECU 554, the engine ECU 570, the degradation detector 564, and/or the algorithm component 565 may be configured to, and/or provide means for, performing the method 2300 of implementing energy management.

At 2305, the method 2300 may include determining, based on the alternator capability signal, an alternator power capability limit. For example, the alternator 420, the controller 190, the power distribution device 124, the power distribution ECU 552, and/or the power generator ECU 550, may be configured to, and/or provide means for, determining, based on the alternator capability signal, an alternator power capability limit.

At 2310, the method 2300 may include comparing the alternator power capability limit to the alternator power indicated in the alternator power present value signal. For example, the controller 190, the power distribution device 124, the power distribution ECU 552, and/or the algorithm component 565 may be configured to, and/or provide means for, comparing the alternator power capability limit to the alternator power indicated in the alternator power present value signal.

At 2315, the method 2300 may include determining that the alternator power is higher than the alternator power capability limit. For example, the controller 190, the power distribution device 124, the power distribution ECU 552, and/or the algorithm component 565 may be configured to, and/or provide means for, determining that the alternator power is higher than the alternator power capability limit.

At 2320, the method 2300 may include transmitting a third signal to the converter to set the converter power limit to a third value. For example, the controller 190, the power distribution device 124, and/or the power distribution ECU 552 may be configured to, and/or provide means for, transmitting a third signal to the converter to set the converter power limit to a third value.

Aspects of the present disclosure include a method of energy management including determining, based on the alternator capability signal, an alternator power capability limit, comparing the alternator power capability limit to the alternator power indicated in the alternator power present value signal, determining that the alternator power is higher than the alternator power capability limit, and transmitting a third signal to the converter to set the converter power limit to a third value.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A method can include detecting a belt slip of a belt coupled to an engine and an alternator, setting a power output limit of the alternator based on a pulley ratio of the belt, an engine speed of the engine, and an alternator speed of the alternator, and decreasing a voltage setpoint of a voltage converter connected to the alternator from a nominal voltage setpoint to a minimum voltage setpoint, wherein the minimum voltage setpoint can be based on the power output limit of the alternator.

Example 2. The method of any example herein, particularly Example 1, wherein detecting the belt slip can include calculating a slip value based on the pulley ratio, the engine speed, and the alternator speed, wherein the slip value can be greater than a slip value threshold.

Example 3. The method of any example herein, particularly Example 2, wherein the slip value can be given by the equation:

$${ρ}_{slip} = \vert \frac{100 ( {ω}_{engine} {φ}_{p ulley} )}{{ω}_{alternator}} - 100 \vert$$

wherein ρₛₗᵢₚ is the slip value, ω_{engine} is the engine speed, ωₐₗₜₑᵣₙₐₜₒᵣ is the alternator speed, and pulley is the pulley ratio.

Example 4. The method of any example herein, particularly any one of Examples 1-3, wherein setting the alternator power output limit can include receiving a torque output of the alternator, determining an allowable alternator torque limit for the alternator based on the engine speed, wherein the torque output of the alternator can be greater than the allowable alternator torque limit, and decreasing the alternator power output limit to a minimum power output limit.

Example 5. The method of any example herein, particularly any one of Examples 1-4, wherein the alternator can be a 48-volt alternator.

Example 6. A method can include, for each DC-DC voltage converter in a plurality of DC-DC voltage converters, measuring a power output of the DC-DC voltage converter and receiving a power capability of the DC-DC voltage converter. The method can further include, for each DC-DC voltage converter in the plurality of DC-DC voltage converters whose power output exceeds its power capability, setting a voltage setpoint of the DC-DC voltage converter to a minimum voltage setpoint. The method can further include, for each DC-DC voltage converter in the plurality of DC-DC voltage converters whose power output does not exceed its power capability, setting the voltage setpoint of the DC-DC voltage converter to a nominal voltage setpoint greater than the minimum voltage setpoint.

Example 7. The method of any example herein, particularly Example 6, can further include, prior to setting the voltage setpoints of the DC-DC voltage converters, setting a power output limit of an alternator to a minimum power output limit, wherein the minimum voltage setpoints of the DC-DC voltage converters can be based on the minimum power output limit of the alternator.

Example 8. The method of any example herein, particularly Example 7, wherein each one of the plurality of DC-DC voltage converters can be coupled to a respective one of a plurality of battery packs, and the minimum power output limit of the alternator can be equal to a difference of an amount of power consumed by electrical loads connected to the plurality of DC-DC voltage converters and an amount of power output by the plurality of battery packs.

Example 9. The method of any example herein, particularly any one of Examples 7-8, wherein the alternator can be a 48-volt alternator.

Example 10. The method of any example herein, particularly any one of Examples 6-9, wherein the voltage setpoints can be decreased to the minimum voltage setpoint at a first slew rate, the voltage setpoints can be increased to the nominal voltage setpoint at a second slew rate, and the first slew rate can be different than the second slew rate.

Example 11. A method can include calculating a slip value based on a pulley ratio of a belt coupled to an engine and an alternator, an engine speed, and an alternator speed, wherein the slip value can be greater than a slip value threshold, and decreasing a power output limit of the alternator to a minimum power output limit.

Example 12. The method of any example herein, particularly Example 11, wherein the slip value can be defined by:

$${ρ}_{slip} = \vert \frac{100 ( {ω}_{engine} {φ}_{p ulley} )}{{ω}_{alternator}} - 100 \vert$$

wherein ρₛₗᵢₚ is the slip value, ω_{engine} is the engine speed, ωₐₗₜₑᵣₙₐₜₒᵣ is the alternator speed, and φ_{pulley} is the pulley ratio.

Example 13. The method of any example herein, particularly any one of Examples 11-12, wherein the slip value can be greater than the slip value threshold over a threshold time period.

Example 14. The method of any example herein, particularly any one of Examples 11-13, which can further include, prior to calculating the slip value, selecting the slip value threshold based on the engine speed.

Example 15. The method of any example herein, particularly Example 14, wherein the slip value threshold can be selected from a lookup table indexed to the engine speed.

Example 16. The method of any example herein, particularly any one of Examples 11-15, wherein the engine speed can be synchronized with the alternator speed.

Example 17. The method of any example herein, particularly any one of Examples 11-16, which can further include, after calculating the slip value and prior to decreasing the power output limit of the alternator, filtering the slip value using a filter.

Example 18. The method of any example herein, particularly Example 17, wherein the filter can be an IIR filter.

Example 19. The method of any example herein, particularly any one of Examples 11-18, which can further include, after calculating the slip value, maturing a diagnostic test code (DTC).

Example 20. The method of any example herein, particularly any one of Examples 11-19, wherein the alternator can be a 48-volt alternator.

The features described herein with regard to any example can be combined with other features described in any one or more of the other examples, unless otherwise stated. For example, any one or more of the features of one motor vehicle can be combined with any one or more features of another motor vehicle. As another example, any one or more features of one method can be combined with any one or more features of another method.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A method for energy management, comprising:
obtaining an engine speed of an engine, an alternator speed of an alternator, and a pulley ratio associated with the engine and the alternator;
calculating a belt slip value of a belt coupled to the engine and the alternator based on at least one of the engine speed, the alternator speed, or the pulley ratio;
detecting a belt slip of the alternator based on the belt slip value and a slip threshold value; and
decreasing, in response to detecting the belt slip, a voltage setpoint of a converter connected to the alternator from an initial voltage setpoint to a target voltage setpoint.

2. The method of claim 1, further comprising:
obtaining one or more calibration values;
synchronizing the engine speed to the alternator speed using the one or more calibration values to generate at least one of a calibrated engine speed and a calibrated alternator speed; and
wherein calculating the belt slip value comprises calculating the belt slip value based on the calibrated engine speed, the calibrated alternator speed, and the pulley ratio.

3. The method of claim 1, where calculating the belt slip value comprises calculating based on an equation:
$${ρ}_{slip} = \vert \frac{100 ( {ω}_{engine} {φ}_{p ulley} )}{{ω}_{alternator}} - 100 \vert$$
wherein ρₛₗᵢₚ is the belt slip value, ω_{engine} is the engine speed, ωₐₗₜₑᵣₙₐₜₒᵣ is the alternator speed, and φ_{pulley} is the pulley ratio.

4. The method of claim 1, wherein detecting the belt slip comprises:
comparing the belt slip value to the slip threshold value; and
determining that the belt slip value is greater than the slip threshold value.

5. The method of claim 4, wherein detecting the belt slip further comprises determining that the belt slip value is greater than the slip threshold value for a period longer than a threshold period.

6. The method of claim 1, further comprising, after calculating the belt slip value:
filtering a belt slip value to generate a filtered belt slip value;
wherein detecting the belt slip comprises:
comparing the filtered belt slip value to the slip threshold value; and
determining that the filtered belt slip value is greater than the slip threshold value for a period longer than a threshold period.

7. The method of claim 1, wherein decreasing the voltage setpoint of a converter comprises:
decreasing the voltage setpoint at a rate until reaching the target voltage setpoint; and
maintaining the voltage setpoint at the target voltage setpoint for a predetermined time.

8. A power distribution device, comprising:
one or more memories; and
one or more processors communicatively coupled to the one or more memories and configured to:
obtain an engine speed of an engine, an alternator speed of an alternator, and a pulley ratio associated with the engine and the alternator;
calculate a belt slip value of a belt coupled to the engine and the alternator based on at least one of the engine speed, the alternator speed, or the pulley ratio;
detect a belt slip of the alternator based on the belt slip value and a slip threshold value; and
decrease, in response to detecting the belt slip, a voltage setpoint of a converter connected to the alternator from an initial voltage setpoint to a target voltage setpoint.

9. The power distribution device of claim 8, wherein the one or more processors are further configured to:
obtain one or more calibration values; and
synchronize the engine speed to the alternator speed using the one or more calibration values to generate at least one of a calibrated engine speed and a calibrated alternator speed;
wherein the one or more processors are further configured to calculate the belt slip value by calculating the belt slip value based on the calibrated engine speed, the calibrated alternator speed, and the pulley ratio.

10. The power distribution device of claim 8, wherein the one or more processors are further configured to calculate the belt slip value by calculating based on an equation:
$${ρ}_{slip} = \vert \frac{100 ( {ω}_{engine} {φ}_{p ulley} )}{{ω}_{alternator}} - 100 \vert$$
wherein ρₛₗᵢₚ is the belt slip value, ω_{engine} is the engine speed, ωₐₗₜₑᵣₙₐₜₒᵣ is the alternator speed, and φ_{pulley} is the pulley ratio.

11. The power distribution device of claim 8, wherein the one or more processors are further configured to detect the belt slip by:
comparing the belt slip value to the slip threshold value; and
determining that the belt slip value is greater than the slip threshold value.

12. The power distribution device of claim 11, wherein the one or more processors are further configured to detect the belt slip by determining that the belt slip value is greater than the slip threshold value for a period longer than a threshold period.

13. The power distribution device of claim 8, wherein the one or more processors are further configured to, after calculating the belt slip value:
filter a belt slip value to generate a filtered belt slip value;
wherein the one or more processors are further configured to detect the belt slip by:
comparing the filtered belt slip value to the slip threshold value; and
determining that the filtered belt slip value is greater than the slip threshold value for a period longer than a threshold period.

14. The power distribution device of claim 8, wherein the one or more processors are further configured to decrease the voltage setpoint of a converter by:
decreasing the voltage setpoint at a rate until reaching the target voltage setpoint; and
maintaining the voltage setpoint at the target voltage setpoint for a predetermined time.

15. A non-transitory computer readable medium including instructions stored therein that, when executed by one or more processors of a power distribution device, cause the one or more processors to:
obtain an engine speed of an engine, an alternator speed of an alternator, and a pulley ratio associated with the engine and the alternator;
calculate a belt slip value of a belt coupled to the engine and the alternator based on at least one of the engine speed, the alternator speed, or the pulley ratio;
detect a belt slip of the alternator based on the belt slip value and a slip threshold value; and
decrease, in response to detecting the belt slip, a voltage setpoint of a converter connected to the alternator from an initial voltage setpoint to a target voltage setpoint.

16. The non-transitory computer readable medium of claim 15, further comprising instructions for:
obtaining one or more calibration values;
synchronizing the engine speed to the alternator speed using the one or more calibration values to generate at least one of a calibrated engine speed and a calibrated alternator speed; and
wherein calculating the belt slip value comprises calculating the belt slip value based on the calibrated engine speed, the calibrated alternator speed, and the pulley ratio.

17. The non-transitory computer readable medium of claim 15, where the instructions for calculating the belt slip value comprises instructions for calculating based on an equation:
$${ρ}_{slip} = \vert \frac{100 ( {ω}_{engine} {φ}_{p ulley} )}{{ω}_{alternator}} - 100 \vert$$
wherein ρₛₗᵢₚ is the belt slip value, ω_{engine} is the engine speed, ωₐₗₜₑᵣₙₐₜₒᵣ is the alternator speed, and φ_{pulley} is the pulley ratio.

18. The non-transitory computer readable medium of claim 17, wherein the instructions for detecting the belt slip further comprises instructions for determining that the belt slip value is greater than the slip threshold value for a period longer than a threshold period.

19. The non-transitory computer readable medium of claim 15, further comprises the instructions for, after calculating the belt slip value:
filtering a belt slip value to generate a filtered belt slip value;
wherein detecting the belt slip comprises:
comparing the filtered belt slip value to the slip threshold value; and
determining that the filtered belt slip value is greater than the slip threshold value for a period longer than a threshold period.

20. The non-transitory computer readable medium of claim 15, wherein the instructions for decreasing the voltage setpoint of a converter further comprises instructions for:
decreasing the voltage setpoint at a rate until reaching the target voltage setpoint; and
maintaining the voltage setpoint at the target voltage setpoint for a predetermined time.
